(19) United States
(12) Patent Application Publication
(10) Pub. No.: US 2011/0038418 A1
(43) Pub. Date: Feb. 17, 2011

(54) CODE OF DEPTH SIGNAL

(75) Inventors: Purvin Bibbhas Pandit, Franklin Park, NJ (US); Peng Yin, Ithaca, NY (US); Dong Tian, Plainsboro, NJ (US)

Correspondence Address: Robert D. Shedd, Patent Operations;THOMSON Licensing LLC, P.O. Box 5312, Princeton, NJ, 08543-5312, US

(73) Assignee: Thomson Licensing

(21) Appl. No.: 12/736,591

(22) PCT Filed: Apr. 24, 2009
(86) PCT No.: PCT/US2009/002539

§ 371 Date: Oct. 21, 2010

Related U.S. Application Data
(60) Provisional application No. 61/125,674, filed on Apr. 25, 2008.

(51) Int. Cl. H04N 7/26

(52) U.S. Cl. 375/240.16; 375/E07.125

(57) ABSTRACT

Various implementations are described. Several implementations relate to determining, providing, or using a depth value representative of an entire coding partition. According to a general aspect, a first portion of an image is encoded using a first-portion motion vector that is associated with the first portion and is not associated with other portions of the image. The first portion has a first size. A first-portion depth value is determined that provides depth information for the entire first portion and not for other portions. A second portion of an image is encoded using a second-portion motion vector that is associated with the second portion and is not associated with other portions of the image. The second portion has a second size that is different from the first size. A second-portion depth value is determined that provides depth information for the entire second portion and not for other portions.

### CROSS-REFERENCE TO RELATED APPLICATIONS

This application claims the benefit of U.S. Provisional Application Ser. No. 61/125,674, filed on Apr. 25, 2008, titled “Coding of Depth Signal”, the contents of which are hereby incorporated by reference in their entirety for all purposes.

### TECHNICAL FIELD

Implementations are described that relate to coding systems. Various particular implementations relate to coding of a depth signal.

### BACKGROUND

Multi-view Video Coding (for example, the MVC extension to H.264/MPEG-4 AVC, or other standards, as well as non-standardized approaches) is a key technology that serves a wide variety of applications, including free-viewpoint and D video applications, home entertainment and surveillance. Depth data may be associated with each view and used, for example, for view synthesis. In those multi-view applications, the amount of video and depth data involved is generally enormous. Thus, there exists the desire for a framework that helps to improve the coding efficiency of current video coding solutions.

### SUMMARY

According to a general aspect, an encoded first portion of an image is decoded using a first-portion motion vector associated with the first portion and not associated with other portions of the image. The first-portion motion vector indicates a corresponding portion in a reference image to be used in decoding the first portion, and the first portion has a first size. A first-portion depth value is processed. The first-portion depth value provides depth information for the entire first portion and not for other portions. An encoded second portion of the image is decoded using a second-portion motion vector associated with the second portion and not associated with other portions of the image. The second-portion motion vector indicates a corresponding portion in the reference image to be used in decoding the second portion. The second portion has a second size that is different from the first size. A second-portion depth value is processed. The second-portion depth value provides depth information the entire second portion and not for other portions.

According to another general aspect, a video signal or a video signal structure includes the following sections. A first image section is included for an encoded first portion of an image. The first portion has a first size. A first depth section is included for a first-portion depth value. The first-portion depth value provides depth information for the entire first portion and not for other portions. A first motion-vector section is included for a first-portion motion vector used in encoding the first portion of the image. The first-portion motion vector is associated with the first portion and is not associated with other portions of the image. The first-portion motion vector indicates a corresponding portion in a reference image to be used in decoding the first portion. A second image section is included for an encoded second portion of an image. The second portion has a second size that is different from the first size. A second depth section is included for a second-portion depth value. The second-portion depth value provides depth information for the entire second portion and not for other portions. A second motion-vector section is included for a second-portion motion vector used in encoding the second portion of the image. The second-portion motion vector is associated with the second portion and is not associated with other portions of the image. The second-portion motion vector indicates a corresponding portion in a reference image to be used in decoding the second portion.

According to another general aspect, a first portion of an image is encoded using a first-portion motion vector that is associated with the first portion and is not associated with other portions of the image. The first-portion motion vector indicates a corresponding portion in a reference image to be used in encoding the first portion. The first portion has a first size. A first-portion depth value is determined that provides depth information for the entire first portion and not for other portions. A second portion of an image is encoded using a second-portion motion vector that is associated with the second portion and is not associated with other portions of the image. The second-portion motion vector indicates a corresponding portion in a reference image to be used in encoding the second portion, and the second portion has a second size that is different from the first size. A second-portion depth value is determined that provides depth information for the entire second portion and not for other portions. The encoded first portion, the first-portion depth value, the encoded second portion, and the second-portion depth value are assembled into a structured format.

The details of one or more implementations are set forth in the accompanying drawings and the description below. Even if described in one particular manner, it should be clear that implementations may be configured or embodied in various manners. For example, an implementation may be performed as a method, or embodied as apparatus, such as, for example, an apparatus configured to perform a set of operations or an apparatus storing instructions for performing a set of operations, or embodied in a signal. Other aspects and features will become apparent from the following detailed description considered in conjunction with the accompanying drawings and the claims.

### BRIEF DESCRIPTION OF THE DRAWINGS

FIG. 1 is a diagram of an implementation of an encoder.

FIG. 2 is a diagram of an implementation of a decoder.

FIG. 3 is a diagram of an implementation of a video transmission system.

FIG. 4 is a diagram of an implementation of a video receiving system.

FIG. 5 is a diagram of an implementation of a video processing device.

FIG. 6 is a diagram of an implementation of a multi-view coding structure with hierarchical B pictures for both temporal and inter-view prediction.

FIG. 7 is a diagram of an implementation of a system for transmitting and receiving multi-view video with depth information.

FIG. 8 is a diagram of an implementation of a framework for generating nine output views (N=9) out of 3 input views with depth (K=3).

FIG. 9 is an example of a depth map.

FIG. 10 is a diagram of an example of a depth signal equivalent to quarter resolution.

FIG. 11 is a diagram of an example of a depth signal equivalent to one eight resolution.

FIG. 12 is a diagram of an example of a depth signal equivalent to one sixteenth resolution.

FIG. 13 is a diagram of an implementation of a first encoding process.

FIG. 14 is a diagram of an implementation of a first decoding process.

FIG. 15 is a diagram of an implementation of a second encoding process.

FIG. 16 is a diagram of an implementation of a second decoding process.

FIG. 17 is a diagram of an implementation of a third encoding process.

FIG. 18 is a diagram of an implementation of a third decoding process.

### DETAILED DESCRIPTION

In at least one implementation, we propose a framework to code a depth signal. In at least one implementation, we propose to code the depth value of the scene as part of the video signal. In at least one implementation described herein we treat the depth signal as an additional component of the motion vector for inter-predicted macroblocks. In at least one implementation, in the case of intra-predicted macroblocks, we send the depth value as a single value along with the intra-mode.

Thus, at least one problem addressed by at least some implementations is the efficient coding of a depth signal for multi-view video sequences (or for single-view video sequences). A multi-view video sequence is a set of two or more video sequences that capture the same scene from different view points. In addition to the scene, a depth signal may be present for each view in order to allow the generation of intermediate views using view synthesis.

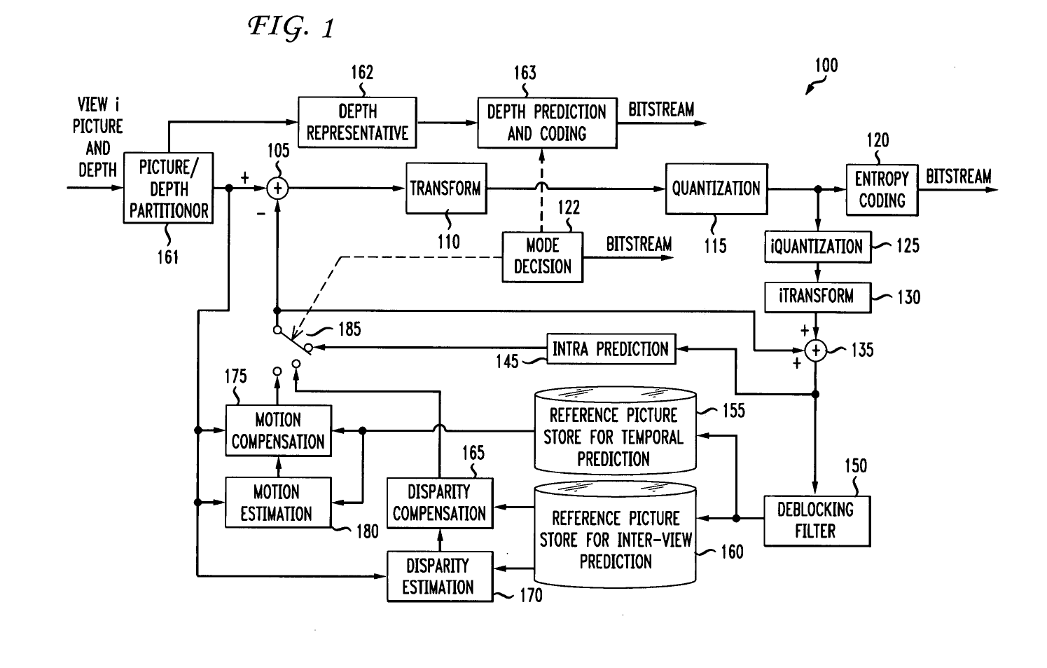

FIG. 1 shows an encoder 100 to which the present principles may be applied, in accordance with an embodiment of the present principles. The encoder 100 includes a combiner 105 having an output connected in signal communication with an input of a transformer 110. An output of the transformer 110 is connected in signal communication with an input of quantizer 115. An output of the quantizer 115 is connected in signal communication with an input of an entropy coder 120 and an input of an inverse quantizer 125. An output of the inverse quantizer 125 is connected in signal communication with an input of an inverse transformer 130. An output of the inverse transformer 130 is connected in signal communication with a first non-inverting input of a combiner 135. An output of the combiner 135 is connected in signal communication with an input of an intra predictor 145 and an input of a deblocking filter 150. The deblocking filter 150 removes, for example, artifacts along macroblock boundaries. A first output of the deblocking filter 150 is connected in signal communication with an input of a reference picture store 155 (for temporal prediction) and a first input of a reference picture store 160 (for inter-view prediction). An output of the reference picture store 155 is connected in signal communication with a first input of a motion compensator 175 and a first input of a motion estimator 180. An output of the motion estimator 180 is connected in signal communication with a second input of the motion compensator 175. A first output of the reference picture store 160 is connected in signal communication with a first input of a disparity estimator 170. A second output of the reference picture store 160 is connected in signal communication with a first input of a disparity compensator 165. An output of the disparity estimator 170 is connected in signal communication with a second input of the disparity compensator 165.

An output of the entropy decoder 120, a first output of a mode decision module 115, and an output of a depth predictor and coder 163, are each available as respective outputs of the encoder 100, for outputting a bitstream. An input of a picture/depth partitioner is available as an input to the encoder, for receiving picture and depth data for view i.

An output of the motion compensator 175 is connected in signal communication with a first input of a switch 185. An output of the disparity compensator 165 is connected in signal communication with a second input of the switch 185. An output of the intra predictor 145 is connected in signal communication with a third input of the switch 185. An output of the switch 185 is connected in signal communication with an inverting input of the combiner 105 and with a second non-inverting input of the combiner 135. A first output of the mode decision module 115 determines which input is provided to the switch 185. A second output of the mode decision module 115 is connected in signal communication with a second input of the depth predictor and coder 163.

A first output of the picture/depth partitioner 161 is connected in signal communication with an input of a depth representative calculator 162. An output of the depth representative calculator 162 is connected in signal communication with a first input of the depth predictor and coder 163. A second output of the picture/depth partitioner 161 is connected in signal communication with a non-inverting input of the combiner 105, a third input of the motion compensator 175, a second input of the motion estimator 180, and a second input of the disparity estimator 170.

Portions of FIG. 1 may also be referred to as an encoder, an encoding unit, or an accessing unit, such as, for example, blocks 110, 115, and 120, either individually or collectively. Similarly, blocks 125, 130, 135, and 150, for example, may be referred to as a decoder or decoding unit, either individually or collectively.

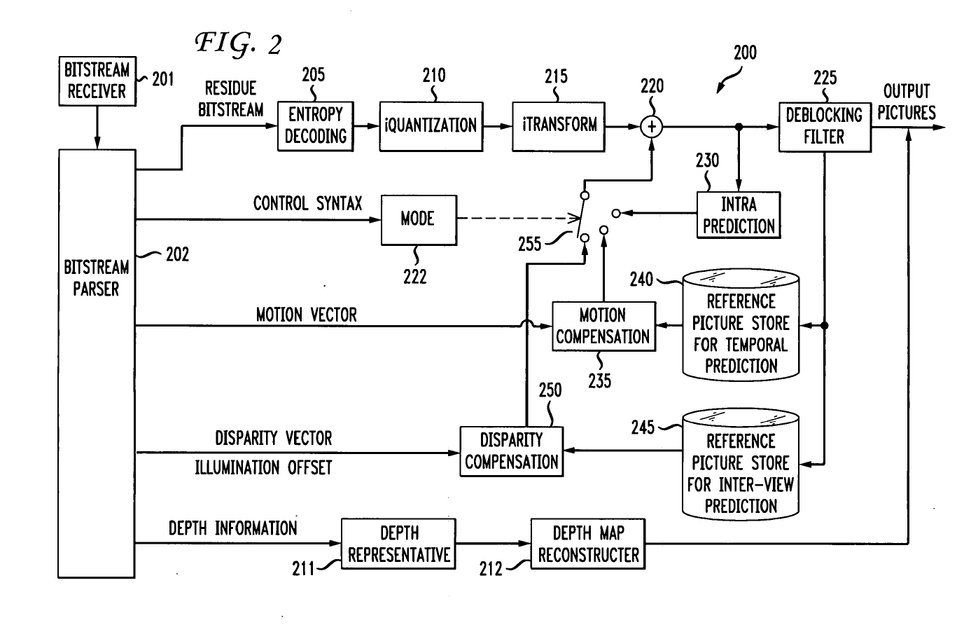

FIG. 2 shows a decoder 200 to which the present principles may be applied, in accordance with an embodiment of the present principles. The decoder 200 includes an entropy decoder 205 having an output connected in signal communication with an input of an inverse quantizer 210. An output of the inverse quantizer is connected in signal communication with an input of an inverse transformer 215. An output of the inverse transformer 215 is connected in signal communication with a first non-inverting input of a combiner 220. An output of the combiner 220 is connected in signal communication with an input of a deblocking filter 225 and an input of an intra predictor 230. A first output of the deblocking filter 225 is connected in signal communication with an input of a reference picture store 240 (for temporal prediction), and a first input of a reference picture store 245 (for inter-view prediction). An output of the reference picture store 240 is connected in signal communication with a first input of a motion compensator 235. An output of a reference picture store 245 is connected in signal communication with a first input of a disparity compensator 250.

An output of a bitstream receiver 201 is connected in signal communication with an input of a bitstream parser 202. A first output (for providing a residue bitstream) of the bitstream parser 202 is connected in signal communication with an input of the entropy decoder 205. A second output (for providing control syntax to control which input is selected by the switch 255) of the bitstream parser 202 is connected in signal communication with an input of a mode selector 222. A third output (for providing a motion vector) of the bitstream parser 202 is connected in signal communication with a second input of the motion compensator 235. A fourth output (for providing a disparity vector and/or illumination offset) of the bitstream parser 202 is connected in signal communication with a second input of the disparity compensator 250. A fifth output (for providing depth information) of the bitstream parser 202 is connected in signal communication with an input of a depth representative calculator 211. It is to be appreciated that illumination offset is an optional input and may or may not be used, depending upon the implementation.

An output of a switch 255 is connected in signal communication with a second non-inverting input of the combiner 220. A first input of the switch 255 is connected in signal communication with an output of the disparity compensator 250. A second input of the switch 255 is connected in signal communication with an output of the motion compensator 235. A third input of the switch 255 is connected in signal communication with an output of the intra predictor 230. An output of the mode module 222 is connected in signal communication with the switch 255 for controlling which input is selected by the switch 255. A second output of the deblocking filter 225 is available as an output of the decoder 200.

An output of the depth representative calculator 211 is connected in signal communication with an input of a depth map reconstructer 212. An output of the depth map reconstructer 212 is available as an output of the decoder 200.

Portions of FIG. 2 may also be referred to as an accessing unit, such as, for example, bitstream parser 202 and any other block that provides access to a particular piece of data or information, either individually or collectively. Similarly, blocks 205, 210, 215, 220, and 225, for example, may be referred to as a decoder or decoding unit, either individually or collectively.

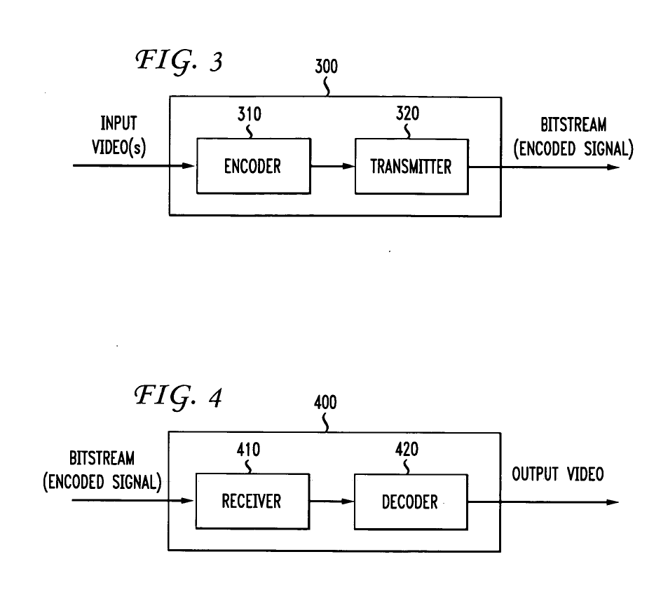

FIG. 3 shows a video transmission system 300, to which the present principles may be applied, in accordance with an implementation of the present principles. The video transmission system 300 may be, for example, a head-end or transmission system for transmitting a signal using any of a variety of media, such as, for example, satellite, cable, telephone-line, or terrestrial broadcast. The transmission may be provided over the Internet or some other network.

The video transmission system 300 is capable of generating and delivering video content encoded using any of a variety of modes. This may be achieved, for example, by generating an encoded signal(s) including depth information or information capable of being used to synthesize the depth information at a receiver end that may, for example, have a decoder.

The video transmission system 300 includes an encoder 310 and a transmitter 320 capable of transmitting the encoded signal. The encoder 310 receives video information and generates an encoded signal(s) therefrom. The encoder 310 may be, for example, the encoder 300 described in detail above. The encoder 310 may include sub-modules, including for example an assembly unit for receiving and assembling various pieces of information into a structured format for storage or transmission. The various pieces of information may include, for example, coded or uncoded video, coded or uncoded depth information, and coded or uncoded elements such as, for example, motion vectors, coding mode indicators, and syntax elements.

The transmitter 320 may be, for example, adapted to transmit a program signal having one or more bitstreams representing encoded pictures and/or information related thereto. Typical transmitters perform functions such as, for example, one or more of providing error-correction coding, interleaving the data in the signal, randomizing the energy in the signal, and modulating the signal onto one or more carriers. The transmitter may include, or interface with, an antenna (not shown). Accordingly, implementations of the transmitter 320 may include, or be limited to, a modulator.

FIG. 4 shows a video receiving system 400 to which the present principles may be applied, in accordance with an embodiment of the present principles. The video receiving system 400 may be configured to receive signals over a variety of media, such as, for example, satellite, cable, telephone-line, or terrestrial broadcast. The signals may be received over the Internet or some other network.

The video receiving system 400 may be, for example, a cell-phone, a computer, a set-top box, a television, or other device that receives encoded video and provides, for example, decoded video for display to a user or for storage. Thus, the video receiving system 400 may provide its output to, for example, a screen of a television, a computer monitor, a computer (for storage, processing, or display), or some other storage, processing, or display device.

The video receiving system 400 is capable of receiving and processing video content including video information. The video receiving system 600 includes a receiver 410 capable of receiving an encoded signal, such as for example the signals described in the implementations of this application, and a decoder 420 capable of decoding the received signal.

The receiver 410 may be, for example, adapted to receive a program signal having a plurality of bitstreams representing encoded pictures. Typical receivers perform functions such as, for example, one or more of receiving a modulated and encoded data signal, demodulating the data signal from one or more carriers, de-randomizing the energy in the signal, de-interleaving the data in the signal, and error-correction decoding the signal. The receiver 410 may include, or interface with, an antenna (not shown). Implementations of the receiver 410 may include, or be limited to, a demodulator.

The decoder 420 outputs video signals including video information and depth information. The decoder 420 may be, for example, the decoder 400 described in detail above.

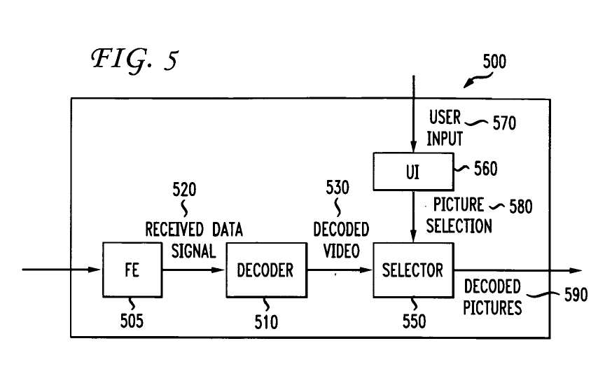

FIG. 5 shows a video processing device 500 to which the present principles may be applied, in accordance with an embodiment of the present principles. The video processing device 500 may be, for example, a set top box or other device that receives encoded video and provides, for example, decoded video for display to a user or for storage. Thus, the video processing device 500 may provide its output to a television, computer monitor, or a computer or other processing device.

The video processing device 500 includes a front-end (FE) device 505 and a decoder 510. The front-end device 505 may be, for example, a receiver adapted to receive a program signal having a plurality of bitstreams representing encoded pictures, and to select one or more bitstreams for decoding from the plurality of bitstreams. Typical receivers perform functions such as, for example, one or more of receiving a modulated and encoded data signal, demodulating the data signal, decoding one or more encodings (for example, channel coding and/or source coding) of the data signal, and/or error-correcting the data signal. The front-end device 505 may receive the program signal from, for example, an antenna (not shown). The front-end device 505 provides a received data signal to the decoder 510.

The decoder 510 receives a data signal 520. The data signal 520 may include, for example, one or more Advanced Video Coding (AVC), Scalable Video Coding (SVC), or Multi-view Video Coding (MVC) compatible streams. The decoder 510 decodes all or part of the received signal 520 and provides as output a decoded video signal 530. The decoded video 530 is provided to a selector 550. The device 500 also includes a user interface 560 that receives a user input 570. The user interface 560 provides a picture selection signal 580, based on the user input 570, to the selector 550. The picture selection signal 580 and the user input 570 indicate which of multiple pictures, sequences, scalable versions, views, or other selections of the available decoded data a user desires to have displayed. The selector 550 provides the selected picture(s) as an output 590. The selector 550 uses the picture selection information 580 to select which of the pictures in the decoded video 530 to provide as the output 590.

In various implementations, the selector 550 includes the user interface 560, and in other implementations no user interface 560 is needed because the selector 550 receives the user input 570 directly without a separate interface function being performed. The selector 550 may be implemented in software or as an integrated circuit, for example. In one implementation, the selector 550 is incorporated with the decoder 510, and in another implementation, the decoder 510, the selector 550, and the user interface 560 are all integrated.

In one application, front-end 505 receives a broadcast of various television shows and selects one for processing. The selection of one show is based on user input of a desired channel to watch. Although the user input to front-end device 505 is not shown in FIG. 5, front-end device 505 receives the user input 570. The front-end 505 receives the broadcast and processes the desired show by demodulating the relevant part of the broadcast spectrum, and decoding any outer encoding of the demodulated show. The front-end 505 provides the decoded show to the decoder 510. The decoder 510 is an integrated unit that includes devices 560 and 550. The decoder 510 thus receives the user input, which is a user-supplied indication of a desired view to watch in the show. The decoder 510 decodes the selected view, as well as any required reference pictures from other views, and provides the decoded view 590 for display on a television (not shown).

Continuing the above application, the user may desire to switch the view that is displayed and may then provide a new input to the decoder 510. After receiving a “view change” from the user, the decoder 510 decodes both the old view and the new view, as well as any views that are in between the old view and the new view. That is, the decoder 510 decodes any views that are taken from cameras that are physically located in between the camera taking the old view and the camera taking the new view. The front-end device 505 also receives the information identifying the old view, the new view, and the views in between. Such information may be provided, for example, by a controller (not shown in FIG. 5) having information about the locations of the views, or the decoder 510. Other implementations may use a front-end device that has a controller integrated with the front-end device.

The decoder 510 provides all of these decoded views as output 590. A post-processor (not shown in FIG. 5) interpolates between the views to provide a smooth transition from the old view to the new view, and displays this transition to the user. After transitioning to the new view, the post-processor informs (through one or more communication links not shown) the decoder 510 and the front-end device 505 that only the new view is needed. Thereafter, the decoder 510 only provides as output 590 the new view.

The system 500 may be used to receive multiple views of a sequence of images, and to present a single view for display, and to switch between the various views in a smooth manner. The smooth manner may involve interpolating between views to move to another view. Additionally, the system 500 may allow a user to rotate an object or scene, or otherwise to see a three-dimensional representation of an object or a scene. The rotation of the object, for example, may correspond to moving from view to view, and interpolating between the views to obtain a smooth transition between the views or simply to obtain a three-dimensional representation. That is, the user may “select” an interpolated view as the “view” that is to be displayed.

Multi-view Video Coding (for example, the MVC extension to H.264/MPEG-4 AVC, or other standards, as well as non-standardized approaches) is a key technology that serves a wide variety of applications, including free-viewpoint and 3D video applications, home entertainment and surveillance. In addition, depth data is typically associated with each view. Depth data is used, for example, for view synthesis. In those multi-view applications, the amount of video and depth data involved is generally enormous. Thus, there exists the desire for a framework that helps improve the coding efficiency of current video coding solutions performing, for example, simulcast of independent views.

Because a multi-view video source includes multiple views of the same scene, there exists a high degree of correlation between the multiple view images. Therefore, view redundancy can be exploited in addition to temporal redundancy and is achieved by performing view prediction across the different views.

In a practical scenario, multi-view video systems will capture the scene using sparsely placed cameras and the views in between these cameras can then be generated using available depth data and captured views by view synthesis/interpolation.

Additionally some views may only carry depth information and the pixel values for those views are then subsequently synthesized at the decoder using the associated depth data. Depth data can also be used to generate intermediate virtual views. Since depth data is transmitted along with the video signal, the amount of data increases. Thus, a desire arises to efficiently compress the depth data.

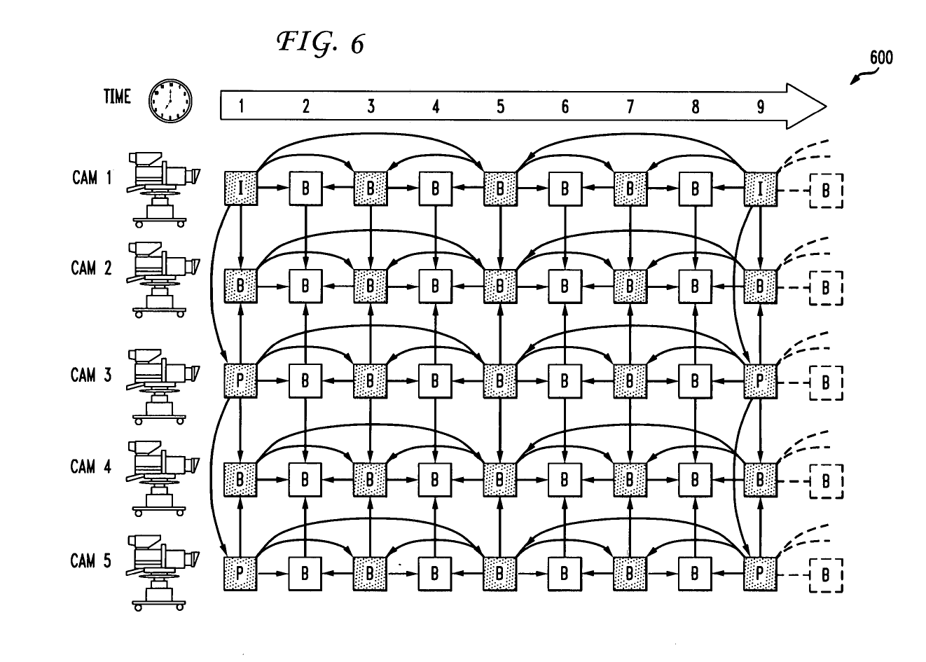

Various methods may be used for depth compression. For example, one technique uses a Region of Interest (ROI)-based coding and Reshaping of the dynamic range of depth in order to reflect the different importance of different depths. Another technique uses a triangular mesh representation for depth signal. Another technique uses a method to compress layered depth images. Another technique uses a method to code depth maps in the wavelet domain. Hierarchical predictive structure and interview prediction are well known to be useful for color video. The interview prediction with a hierarchical prediction structure may be additionally applied for coding the depth map sequences as shown in FIG. 6. In particular, FIG. 6 is a diagram showing a multi-view coding structure with hierarchical B pictures for both temporal and inter-view prediction. In FIG. 6, the arrows going from left to right or right to left indicate temporal prediction, and the arrows going from up to down or from down to up indicate inter-view prediction.

Rather than encoding the depth sequence independently from the color video, implementations may reuse the motion information from the corresponding color video, which may be useful because the depth sequence is often more likely to share the same temporal motion.

FTV (Free-viewpoint TV) is a framework that includes a coded representation for multi-view video and depth information and targets the generation of high-quality intermediate views at the receiver. This enables free viewpoint functionality and view generation for auto-multiscopic displays.

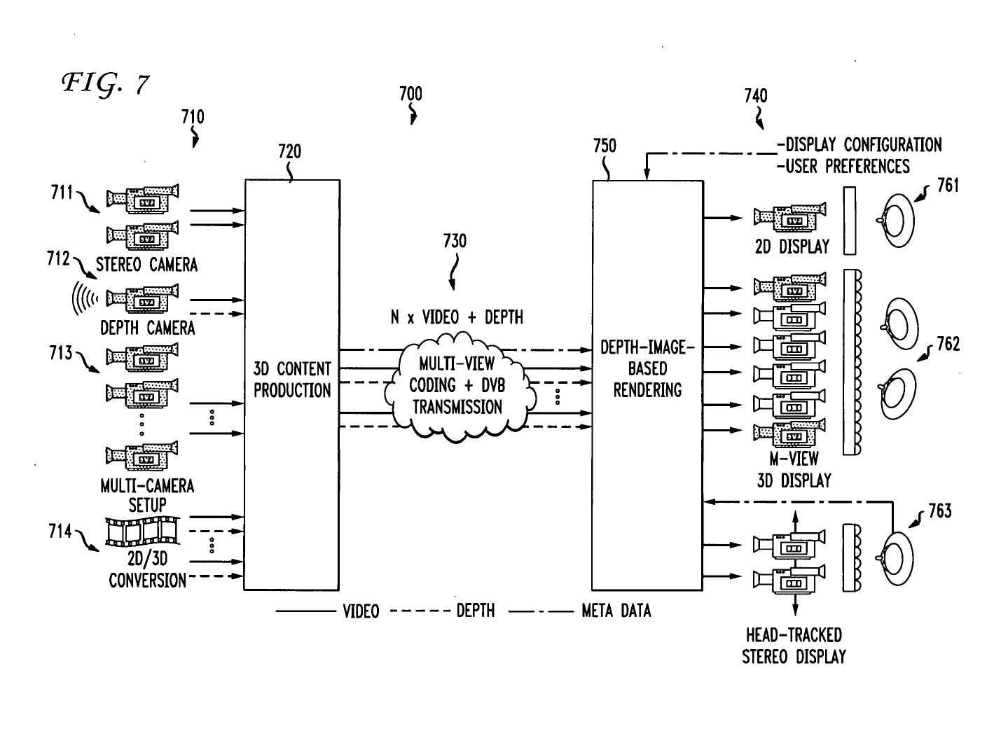

FIG. 7 shows a system 700 for transmitting and receiving multi-view video with depth information, to which the present principles may be applied, according to an embodiment of the present principles. In FIG. 7, video data is indicated by a solid line, depth data is indicated by a dashed line, and meta data is indicated by a dotted line. The system 700 may be, for example, but is not limited to, a free-viewpoint television system. At a transmitter side 710, the system 700 includes a three-dimensional (3D) content producer 720, having a plurality of inputs for receiving one or more of video, depth, and meta data from a respective plurality of sources. Such sources may include, but are not limited to, a stereo camera 111, a depth camera 712, a multi-camera setup 713, and 2-dimensional/3-dimensional (2D/3D) conversion processes 714. One or more networks 730 may be used for transmit one or more of video, depth, and meta data relating to multi-view video coding (MVC) and digital video broadcasting (DVB).

At a receiver side 740, a depth image-based renderer 750 performs depth image-based rendering to project the signal to various types of displays. This application scenario may impose specific constraints such as narrow angle acquisition (<20 degrees). The depth image-based renderer 750 is capable of receiving display configuration information and user preferences. An output of the depth image-based renderer 750 may be provided to one or more of a 2D display 761, an M-view 3D display 762, and/or a head-tracked stereo display 763.

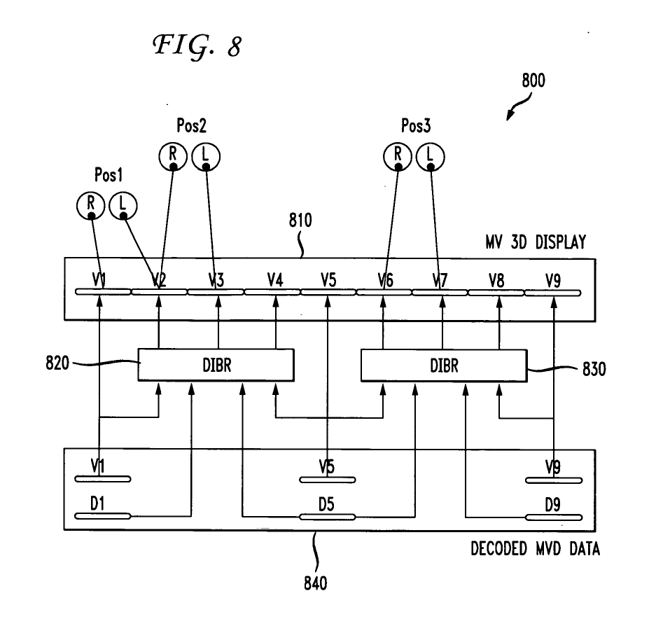

In order to reduce the amount of data to be transmitted, the dense array of cameras (V1, V2 . . . V9) may be sub-sampled and only a sparse set of cameras actually capture the scene. FIG. 8 shows a framework 800 for generating nine output views (N=9) out of 3 input views with depth (K=3), to which the present principles may be applied, in accordance with an embodiment of the present principles. The framework 800 involves an auto-stereoscopic 3D display 810, which supports output of multiple views, a first depth image-based renderer 820, a second depth image-based renderer 830, and a buffer for decoded data 840. The decoded data is a representation known as Multiple View plus Depth (MVD) data. The nine cameras are denoted by V1 through V9. Corresponding depth maps for the three input views are denoted by D1, D5, and D9. Any virtual camera positions in between the captured camera positions (e.g., Pos 1, Pos 2, Pos 3) can be generated using the available depth maps (D1, D5, D9), as shown in FIG. 8.

In at least one implementation described herein, we propose to address the problem of improving the coding efficiency of the depth signal.

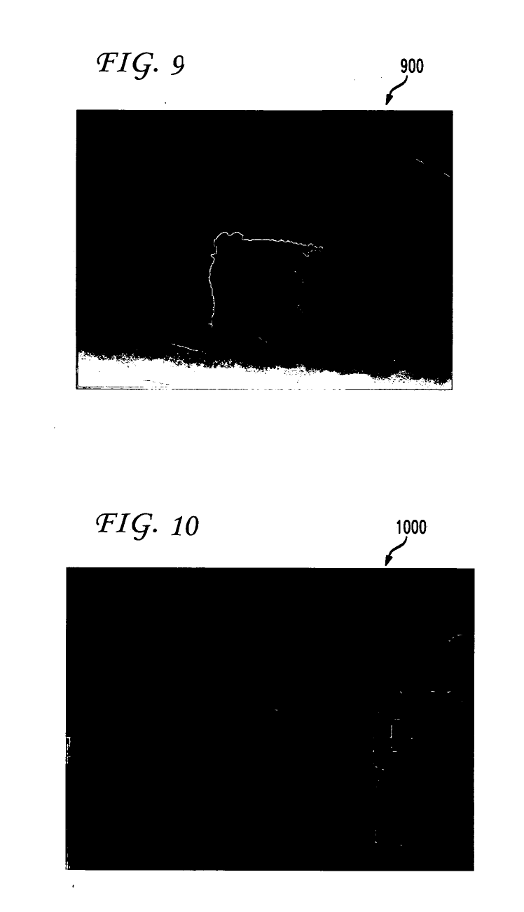

FIG. 9 shows a depth map 900, to which the present principles may be applied, in accordance with an embodiment of the present principles. In particular, the depth map 900 is for view 0. As it can be seen from FIG. 9, the depth signal is relatively flat (the shade of gray represents the depth, and a constant shade represents a constant depth) in many regions, meaning that many regions have a depth value that does not change significantly. There are a lot of smooth areas in the image. As a result, the depth signal can be coded with different resolutions in different regions.

In order to create a depth image, one method involves calculating the disparity image first and converting to the depth image based on the projection matrix. In one implementation, a simple linear mapping of the disparity to a disparity image is represented as follows:

$$Y = 255 * \frac{( d - {d}_{min} )}{( {d}_{max} - {d}_{min} )} \qquad ( 1 )$$

where d is the disparity, dₘᵢₙ and dₘₐₓ are the disparity range, and Y is the pixel value of the disparity image. In this implementation, the pixel value of the disparity image falls within between 0 and 255, inclusive.

The relationship between depth and disparity can be simplified as the following equation, if we assume that, (1) the cameras are arranged in the 1D parallel way; (2) the multi-view sequences are well rectified, that is, the rotation matrix is the same for all views, focal length is the same for all views, the principal points of all the views are along a line which is parallel to the baseline; (3) the axis x of all the camera coordinates are all along with the baseline. The following is performed to calculate the depth value between the 3D point and the camera coordinate:

$$z = \frac{f \cdot l}{d + du} \qquad ( 2 )$$

where f is the focal length, I is the translation amount along the baseline, and du is the difference between the principal point along the baseline.

From Equation (2), it can be derived that the disparity image is the same as its depth image, and the true depth value can be restored as follows:

$$z = \frac{1}{\frac{Y}{255} * ( \frac{1}{{Z}_{near}} - \frac{1}{{Z}_{far}} ) + \frac{1}{{Z}_{far}}} \qquad ( 3 )$$

where Y is the pixel value of the disparity/depth image, Zₙₑₐᵣ and Z_{far} are the depth range, calculated as followings:

$${Z}_{near} = \frac{f * l}{{d}_{max} + du} , {Z}_{far} = \frac{f * l}{{d}_{min} + du} \qquad ( 4 )$$

The depth image based on Equation (1) provides the depth level for each pixel and the true depth value can be derived using Equation (3). In order to reconstruct the true depth value, the decoder uses Zₙₑₐᵣ and Z_{far} in addition to the depth image itself. This depth value can be used for 3D reconstruction.

In traditional video coding, a picture is composed of several macroblocks (MB). Each MB is then coded with a specific coding mode. The mode may be inter or intra mode. Additionally, the macroblocks may be split into sub-macroblock modes. Considering AVC standard, there are several macroblock modes such as intra 16×16, intra 4×4, intra 8×8, inter 16×16 down to inter 4×4. In general, large partitions are used for smooth regions or bigger objects. Smaller partitions may be used more along object boundaries and fine texture. Each intra macroblock has an associated intra prediction mode and an inter macroblock has motion vectors. Each motion vector has 2 components, x and y which represent the displacement of the current macroblock in a reference image. These motion vectors represent the motion of the current macroblock from one picture to another. If the reference picture is an inter-view picture, then the motion vector represents disparity.

In at least one implementation, we propose that (in case of inter macroblocks) in addition to the 2 components of the motion vector (mvx, mvy), an additional component (depth) is transmitted which represents the depth for the current macroblock or sub-macroblock. For intra-macroblocks, in addition to the intra prediction mode, an additional depth signal is transmitted. The amount of depth signal transmitted depends on the macroblock type (16×16, 16×8, 8×16, . . . , 4×4). The rationale behind it is that it will generally suffice to code a very low resolution of depth for smooth regions, and a higher resolution of depth for object boundaries. This corresponds to the properties of motion partitions. The object boundaries (especially in lower depth ranges) in the depth signal have a correlation with the object boundaries in the video signal. Thus, it can be expected that the macroblock modes that are chosen to code these object boundaries for the video signal will be appropriate for the corresponding depth signal also. At least one implementation described herein allows coding the resolution of depth adaptively based on the characteristic of the depth signal which as described herein is closely tied with the characteristics of the video signal especially at object boundaries. After we decode the depth signal, we interpolate the depth signal back to its full resolution.

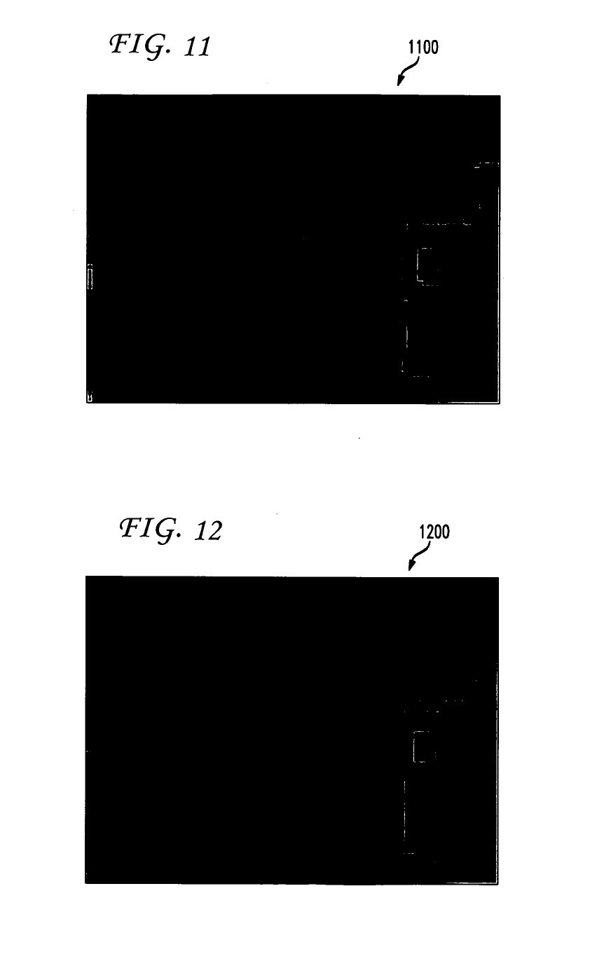

An example of what the depth signals look like when sub-sampled to lower resolutions & then up-sampled by zero-order hold are shown in FIGS. 10, 11, and 12. In particular, FIG. 10 is a diagram showing a depth signal 1000 equivalent to quarter resolution. FIG. 11 is a diagram showing a depth signal 1100 equivalent to one-eighth resolution. FIG. 12 is a diagram showing a depth signal 1200 equivalent to one-sixteenth resolution.

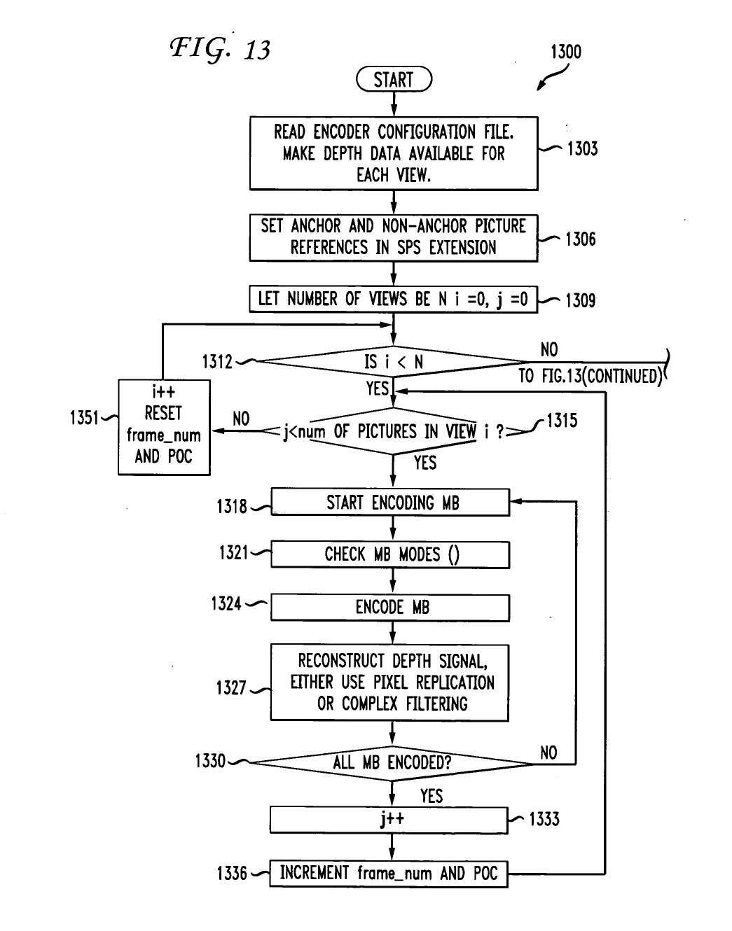

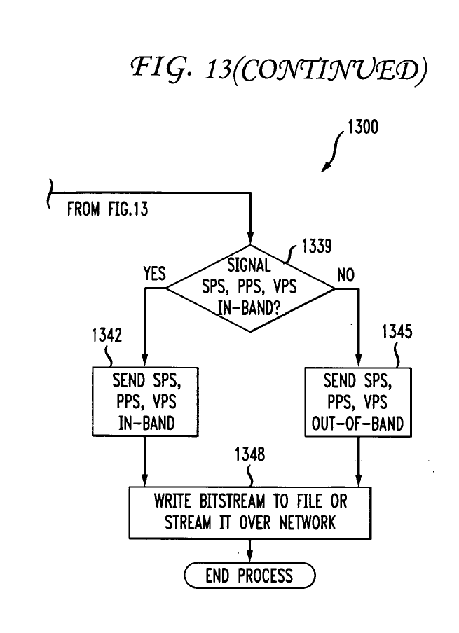

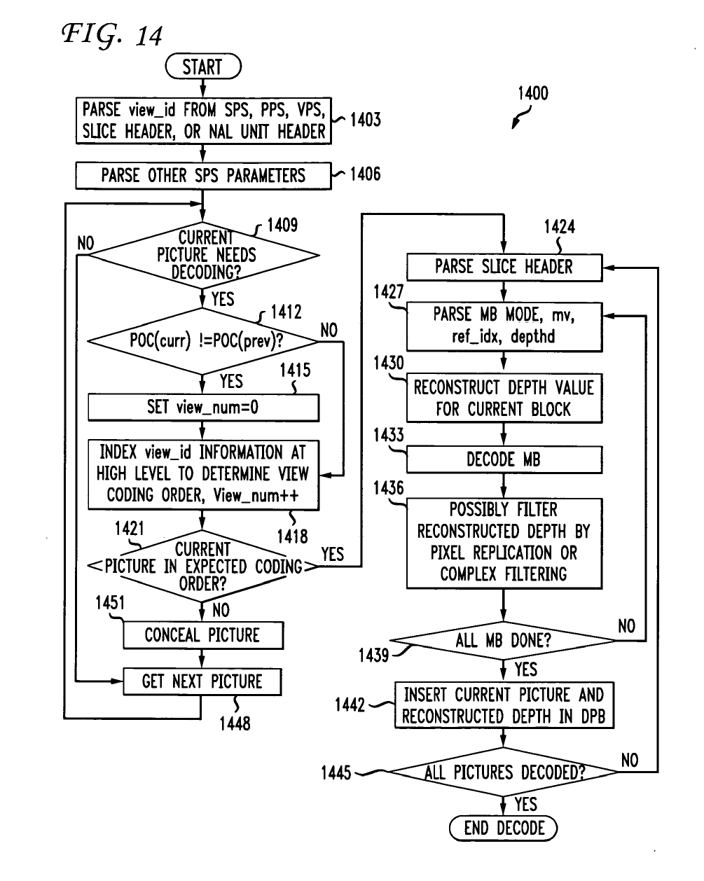

FIGS. 13 and 14 illustrate examples of methods for encoding and decoding, respectively, video data including a depth signal.

In particular, FIG. 13 is a flow diagram showing a method 1300 for encoding video data including a depth signal, in accordance with an embodiment of the present principles. At step 1303, an encoder configuration file is read, and depth data for each view is made available. At step 1306, anchor and non-anchor picture references are set in the SPS extension. At step 1309, N is set to be the number of views, and variables i and j are initialized to 0. At step 1312, it is determined whether or not i<N. If so, then control is passed to a step 1315. Otherwise, control is passed to a step 1339.

At step 1315, it is determined whether or not j<number (num) of pictures in view i. If so, then control is passed to a step 1318. Otherwise, control is passed to a step 1351.

At step 1318, encoding of the current macroblock is commenced. At step 1321, macroblock modes are checked. At step 1324, the current macroblock is encoded. At step 1327, the depth signal is reconstructed either using pixel replication or complex filtering. At step 1330, it is determined whether or not all macroblocks have been encoded. If so, then control is passed to a step 1333. Otherwise, control is returned to step 1315.

At step 1333, variable j is incremented. At step 1336, frame_num and POC are incremented.

At step 1339, it is determined whether or not to signal the SPS, PPS, and/or VPS in-band. If so, then control is passed to a step 1342. Otherwise, control is passed to a step 1345.

At step 1342, the SPS, PPS, and/or VPS are signaled in-band.

At step 1345, the SPS, PPS, and/or VPS are signaled out-of-band.

At step 1348, the bitstream is written to a file or streamed over a network. An assembly unit, such as that described in the discussion of encoder 310, may be used to assemble and write the bitstream.

At step 1351, variable i is incremented, and frame_num and POC are reset.

FIG. 14 is a flow diagram showing a method 1400 for decoding video data including a depth signal, in accordance with an embodiment of the present principles. At step 1403, view_id is parsed from the SPS, PPS, VPS, slice header and/or network abstraction layer (NAL) unit header. At step 1406, other SPS parameters are parsed. At step 1409, it is determined whether or the current picture needs decoding. If so, then control is passed to a step 1412. Otherwise, control is passed to a step 1448.

At step 1412, it is determined whether or not POC(curr) !=POC(prev). If so, then control is passed to a step 1415. Otherwise, control is passed to a step 1418.

At step 1415, view_num is set equal to 0.

At step 1418, view_id information is indexed at a high level to determine the view coding order, and view_num is incremented.

At step 1421, it is determined whether or not the current picture (pic) is in the expected coding order. If so, then control is passed to a step 1424. Otherwise, control is passed to a step 1251.

At step 1424, the slice header is parsed. At step 1427, the macroblock (MB) mode, motion vector (my), ref_idx, and depthd are parsed. At step 1430, the depth value for the current block is reconstructed based on depthd. At step 1433, the current macroblock is decoded. At step 1436, the reconstructed depth is possibly filtered by pixel replication or complex filtering. Step 1436 uses the reconstructed depth value to, optionally, obtain a per-pixel depth map. Step 1436 may use operations such as, for example, repeating the depth value for all pixels associated with the depth value, or filtering the depth value in known ways, including extrapolation and interpolation.

At step 1439, it is determined whether or not all macroblocks are done (being decoded). If so, then control is passed to a step 1442. Otherwise, control is returned to step 1427.

At step 1442, the current picture and the reconstructed depth are inserted into the decoded picture buffer (DPB). At step 1445, it is determined whether or not all pictures have been decoded. If so, then decoding is concluded. Otherwise, control is returned to step 1424.

At step 1448, the next picture is obtained.

At step 1451, the current picture is concealed.

### Embodiment 1

For the first embodiment, the modifications to the slice layer, macroblock layer and sub-macroblock syntax for an AVC decoder are shown in Table 1, Table 2, and Table 3, respectively. As can be seen from the Tables, each macroblock type has an associated depth value. Various portions of Tables 1-3 are emphasized by being italicized. Thus, here we elaborate on how depth is sent for each macroblock type.

TABLE 1

| | | |
|---|---|---|
| slice_data( ) { | C | Descriptor |

if( entropy_coding_mode_flag )

while( !byte_aligned( ) )

| | | |
|---|---|---|
| cabac_alignment_one_bit | 2 | f(1) |

CurrMbAddr = first_mb_in_slice * ( 1 + MbaffFrameFlag )
moreDataFlag = 1
prevMbSkipped = 0
do {

if( slice_type != I && slice_type != SI )

if( !entropy_coding_mode_flag ) {

| | | |
|---|---|---|
| mb_skip_run | 2 | ue(v) |
| prevMbSkipped = ( mb_skip_run > 0 ) | | |
| for( i=0; i<mb_skip_run; i++ ) { | | |

| | | |
|---|---|---|
| depthd[0][0] | 2 | ue(v) \| ae(v) |
| CurrMbAddr = NextMbAddress( CurrMbAddr ) | | |

}
moreDataFlag = more_rbsp_data( )

} else {

| | | |
|---|---|---|
| mb_skip_flag | 2 | ae(v) |
| depthd[0][0] | 2 | ue(v) \| ae(v) |
| moreDataFlag = !mb_skip_flag | | |

}

if( moreDataFlag ) {

if( MbaffFrameFlag && ( CurrMbAddr % 2 = = 0 ||

| | | |
|---|---|---|
| ( CurrMbAddr % 2 = = 1 && prevMbSkipped ) ) ) | | |
| mb_field_decoding_flag | 2 | u(1) \| ae(v) |

| | |
|---|---|
| macroblock_layer( ) | 2 \| 3 \| 4 |

}
if( !entropy_coding_mode_flag )

moreDataFlag = more_rbsp_data( )

else {

if( slice_type != I && slice_type != SI )

prevMbSkipped = mb_skip_flag

if( MbaffFrameFlag && CurrMbAddr % 2 = = 0 )

moreDataFlag = 1

else {

| | | |
|---|---|---|
| end_of_slice_flag | 2 | ae(v) |
| moreDataFlag = !end_of_slice_flag | | |

}

}
CurrMbAddr = NextMbAddress( CurrMbAddr )

} while( moreDataFlag )

}

TABLE 2

| | | |
|---|---|---|
| mb_pred( mb_type ) { | C | Descriptor |

if( MbPartPredMode( mb_type, 0 ) = = Intra_4x4 ||

MbPartPredMode( mb_type, 0 ) = = Intra_8x8 ||
MbPartPredMode( mb_type, 0 ) = = Intra_16x16) {
if( MbPartPredMode( mb_type, 0 ) = = Intra_4x4 )

for( luma4x4BlkIdx=0; luma4x4BlkIdx<16; luma4x4BlkIdx++ ) {

| | | |
|---|---|---|
| prev_intra4x4_pred_mode_flag[ luma4x4BlkIdx ] | 2 | u(1) \| ae(v) |
| if( !prev_intra4x4_pred_mode_flag[ luma4x4BlkIdx ] ) | | |

| | | |
|---|---|---|
| rem_intra4x4_pred_mode[ luma4x4BlkIdx ] | 2 | u(3) \| ae(v) |

| | | |
|---|---|---|
| prev_depth4x4_pred_flag[ luma4x4BlkIdx ] | 2 | u(1) \| ae(v) |
| if( !prev_depth4x4_pred_flag[ luma4x4BlkIdx ] ) | | |

| | | |
|---|---|---|
| rem_depth4x4[ luma4x4BlkIdx ] | 2 | se(v) \| ae(v) |

}

if( MbPartPredMode( mb_type, 0 ) = = Intra_8x8 )

for( luma8x8BlkIdx=0; luma8x8BlkIdx<4; luma8x8BlkIdx++ ) {

| | | |
|---|---|---|
| prev_intra8x8_pred_mode_flag[ luma8x8BlkIdx ] | 2 | u(1) \| ae(v) |
| if( !prev_intra8x8_pred_mode_flag[ luma8x8BlkIdx ] ) | | |

| | | |
|---|---|---|
| rem_intra8x8_pred_mode[ luma8x8BlkIdx ] | 2 | u(3) \| ae(v) |

| | | |
|---|---|---|
| prev_depth8x8_pred_flag[ luma8x8BlkIdx ] | 2 | u(1) \| ae(v) |
| if( !prev_depth8x8_pred flag[ luma8x8BlkIdx ] ) | | |

| | | |
|---|---|---|
| rem_depth8x8[ luma8x8BlkIdx ] | 2 | se(v) \| ae(v) |

}

if( MbPartPredMode( mb type, 0 ) = = Intra 16x16 )

| | | |
|---|---|---|
| depthd[0][0] | 2 | se(v) \| ae(v) |

if( ChromaArrayType = = 1 ||

| | | |
|---|---|---|
| ChromaArrayType = = 2 ) | | |
| Intra_chroma_pred_mode | 2 | ue(v) \| ae(v) |

} else if( MbPartPredMode( mb_type, 0 ) != Direct ) {

for( mbPartIdx = 0; mbPartIdx < NumMbPart( mb_type ); mbPartIdx++)

if( ( num_ref_idx_10_active_minus1 > 0 ||

mb_field_decoding_flag ) &&

| | | |
|---|---|---|
| MbPartPredMode( mb_type, mbPartIdx ) != Pred_L1) | | |
| Ref_idx_10[ mbPartIdx ] | 2 | te(v) \| ae(v) |

for( mbPartIdx = 0; mbPartIdx < NumMbPart( mb_type ); mbPartIdx++)

if( ( num_ref_idx_11_active_minus1 > 0 ||

mb_field_decoding_flag ) &&

| | | |
|---|---|---|
| MbPartPredMode( mb_type, mbPartIdx ) != Pred_L0 ) | | |
| Ref_idx_11[ mbPartIdx ] | 2 | te(v) \| ae(v) |

for( mbPartIdx = 0; mbPartIdx < NumMbPart( mb_type ); mbPartIdx++)

if( MbPartPredMode ( mb_type, mbPartIdx ) != Pred_L1 )

for( compIdx = 0; compIdx < 2; compIdx++ )

| | | |
|---|---|---|
| mvd_10[ mbPartIdx ][ 0 ][ compIdx ] | 2 | se(v) \| ae(v) |

for( mbPartIdx = 0; mbPartIdx < NumMbPart( mb_type ); mbPartIdx++)

if( MbPartPredMode( mb_type, mbPartIdx ) != Pred_L0 )

for( compIdx = 0; compIdx < 2; compIdx++ )

| | | |
|---|---|---|
| mvd_11[ mbPartIdx ][ 0 ][ compIdx ] | 2 | se(v) \| ae(v) |

for( mbPartIdx = 0; mbPartIdx < NumMbPart( mb type ); mbPartIdx ++)

| | | |
|---|---|---|
| depthd[ mbPartIdx ][0] | 2 | se(v) \| ae(v) |

}

}

TABLE 3

| | | |
|---|---|---|
| sub_mb_pred( mb_type ) { | C | Descriptor |

for( mbPartIdx = 0; mbPartIdx < 4; mbPartIdx++ )

| | | |
|---|---|---|
| sub_mb_type[ mbPartIdx ] | 2 | ue(v) \| ae(v) |

for( mbPartIdx = 0; mbPartIdx < 4; mbPartIdx++ )

if( ( num_ref_idx_10_active_minus1 > 0 || mb_field_decoding_flag ) &&

| | | |
|---|---|---|
| mb_type != P_8x8ref0 && | | |
| sub_mb_type[ mbPartIdx ] != B_Direct_8x8 && | | |
| SubMbPredMode( sub_mb_type[ mbPartIdx ] ) != Pred_L1 ) | | |
| ref_idx_10[ mbPartIdx ] | 2 | te(v) \| ae(v) |

for( mbPartIdx = 0; mbPartIdx < 4; mbPartIdx++ )

if( (num_ref_idx_11_active_minus1 > 0 || mb_field_decoding_flag ) &&

| | | |
|---|---|---|
| sub_mb_type[ mbPartIdx ] != B_Direct_8x8 && | | |
| SubMbPredMode( sub_mb_type[ mbPartIdx ] ) != Pred_L0 ) | | |
| ref_idx_11[ mbPartIdx ] | 2 | te(v) \| ae(v) |

for( mbPartIdx = 0; mbPartIdx < 4; mbPartIdx++ )

if( sub_mb_type[ mbPartIdx ] != B_Direct_8x8 &&

SubMbPredMode( sub_mb_type[ mbPartIdx ] ) != Pred_L1 )
for( subMbPartIdx = 0;

```
  subMbPartIdx < NumSubMbPart( sub_mb_type[ mbPartIdx ] );
  subMbPartIdx++)
for( compIdx = 0; compIdx < 2; compIdx++ )
```

| | | |
|---|---|---|
| mvd_10[ mbPartIdx ][ subMbPartIdx ][ compIdx ] | 2 | se(v) \| ae(v) |

for( mbPartIdx = 0; mbPartIdx < 4; mbPartIdx++ )

if( sub_mb_type[ mbPartIdx ] != B_Direct_8x8 &&

SubMbPredMode( sub_mb_type[ mbPartIdx ] ) != Pred_L0 )
for( subMbPartIdx = 0;

```
  subMbPartIdx < NumSubMbPart( sub_mb_type[ mbPartIdx ] );
  subMbPartIdx++)
for( compIdx = 0; compIdx < 2; compIdx++ )
```

| | | |
|---|---|---|
| mvd_11[ mbPartIdx ][ subMbPartIdx ][ compIdx ] | 2 | se(v) \| ae(v) |

for( mbPartIdx = 0; mbPartIdx < 4; mbPartIdx++ )

if( sub_mb_type[ mbPartIdx] != B_Direct_8x8 &&

SubMbPredMode( sub_mb_type[ mbPartIdx ] ) != Pred_L0 )
for( subMbPartIdx = 0;

| | | |
|---|---|---|
| subMbPartIdx < NumSubMbPart( sub_mb_type[ mbPartIdx ] ); | | |
| subMbPartIdx++) | | |
| depthd[ mbPartIdx ][ subMbPartIdx ] | 2 | se(v) \| ae(v) |

}

Broadly speaking there are 2 macroblock types in AVC. One macroblock type is an intra macroblock and the other macroblock type is an inter macroblock. Each of these 2 are further sub-divided into several different sub-macroblock modes.

### Intra Macroblocks

Let us consider the coding of an intra macroblock. An intra macroblock could be an intra4×4, intra8×8, or intra16×16 type.

### Intra4×4

If the macroblock type is intra4×4, then we follow a method similar to the one used to code the intra4×4 prediction mode. As can be seen from Table 2, we transmit 2 values to signal the depth for each 4×4 block. The semantics of the 2 syntax are specified as follows:

prev_depth4×4_pred_mode_flag[luma4×4BlkIdx] and rem_depth4×4[luma4×4BlkIdx] specify the depth prediction of the 4×4 block with index luma4×4BlkIdx=0 . . . 15.
Depth4×4[luma4×4BlkIdx] is derived by applying the following procedure.
predDepth4×4=Min(depthA, depthB),
when mbA is not present,
predDepth4×4=depthB
when mbB is not present,
predDepth4×4=depthA
when mbA and mbB are not present, predDepth4×4=128
if(prev_depth4×4_pred_mode_flag[luma4×4BlkIdx])

Depth4×4[luma4×4BlkIdx]=predDepth4×4

else

Depth4×4[luma4×4BlkIdx]=predDepth4×4+rem_depth4×4[luma4×4BlkIdx]

Here depthA is the reconstructed depth signal of the left neighbor MB and depthB is the reconstructed depth signal of the top neighbor MB.

### Intra8×8

A similar process is applied for macroblocks with intra8×8 prediction mode with 4×4 replaced by 8×8.

### Intra16×16

For intra16×16 intra prediction mode, one option is to explicitly transmit the depth signal of the current macroblock. This is shown in Table 2.

In this case, the syntax in Table 2 would have the following semantics:

depthd[0][0] specifies the depth value to be used for the current macroblock.

Another option is to transmit a differential value compared to the neighboring depth values similar to the intra4×4 prediction mode.

The process for obtaining the depth value for a macroblock with intra16×16 prediction mode can be specified as follows:

predDepth16×16=Min(depthA, depthB)
when mbA is not present,
predDepth16×16=depthB
when mbB is not present,
predDepth16×16=depthA
when mbA and mbB are not present,
predDepth16×16=128
depth16×16=predDepth16×16+depthd[0][0]

In this case, the semantics for the syntax in Table 2 would be specified as follows:

depthd[0][0] specifies the difference between a depth value to be used and its prediction for the current macroblock.

### Inter Macroblocks

There are several types of inter macroblock and sub-macroblock modes specified in the AVC specification. Thus, we specify how the depth is transmitted for each of the cases.

### Direct MB or Skip MB

In the case of skip macroblock, only a single flag is sent since there is no other data associated with the macroblock. All the information is derived from the spatial neighbor (except the residual which is not used). In the case of Direct macroblock, only the residual information is sent and other data is derived from either a spatial or temporal neighbor.

For these 2 modes, there are 2 options of recovering the depth signal.

### Option 1

We can explicitly transmit the depth difference. This is shown in Table 1. The depth is then recovered by using the prediction from its neighbor similar to Intra16×16 mode.

The prediction of the depth value (predDepthSkip) follows a process that is similar to the process specified for motion vector prediction in the AVC specification as follows:

DepthSkip=predDepthSkip+depthd[0][0]

In this case, the semantics for the syntax in Table 2 would be specified as follows:

depthd[0][0] specifies the difference between a depth value to be used and its prediction for the current macroblock.

### Option 2

Alternatively, we could use the prediction signal directly as the depth for the macroblock. Thus, we can avoid transmitting the depth difference. For example the explicit syntax elements of depthd[0][0] in Table 1 can be avoided.

Hence, we would have the following:

DepthSkip=predDepthSkip

### Inter 16×16, 16×8, 8×16 MB

In case of these inter prediction modes, we transmit the depth value for each partition. This is shown in Table 2. We signal the syntax depthd[mbPartIdx][0].

The final depth for the partition is derived as follows:

DepthSkip=predDepthSkip+depthd[mbPartIdx][0]

where the prediction of the depth value (predDepthSkip) follows a process that is similar to the process specified for motion vector prediction in the AVC specification.

The semantics for depthd[mbPartIdx][0] is specified as follows:

depthd[mbPartIdx][0] specifies the difference between a depth value to be used and its prediction. The index mbPartIdx specifies to which macroblock partition depthd is assigned. The partitioning of the macroblock is specified by mb_type.

Sub-MB modes (8×8, 8×4, 4×8, 4×4)

In the case of these inter prediction modes, we transmit the depth value for each partition. This is shown in Table 3. We signal the syntax depthd[mbPartIdx][subMbPartIdx].

The final depth for the partition is derived as follows:

DepthSkip=predDepthSkip+depthd[mbPartIdx][subMbPartIdx]

where the prediction of the depth value (predDepthSkip)) follows a process that is similar to the process specified for motion vector prediction in the AVC specification.

The semantics for depthd[mbPartIdx][subMbPartIdx] is specified as follows:

depthd[mbPartIdx][subMbPartIdx] specifies the difference between a depth value to be used and its prediction. It is applied to the sub-macroblock partition index with subMbPartIdx. The indices mbPartIdx and subMbPartIdx specify to which macroblock partition and sub-macroblock partition depthd is assigned.

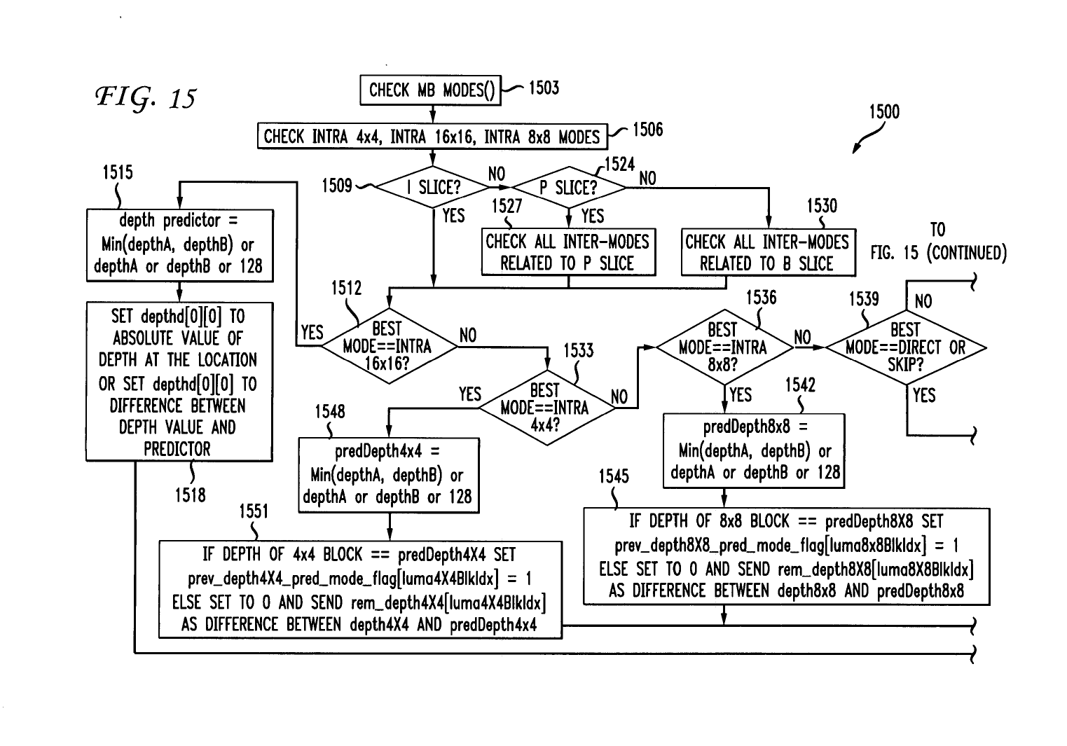

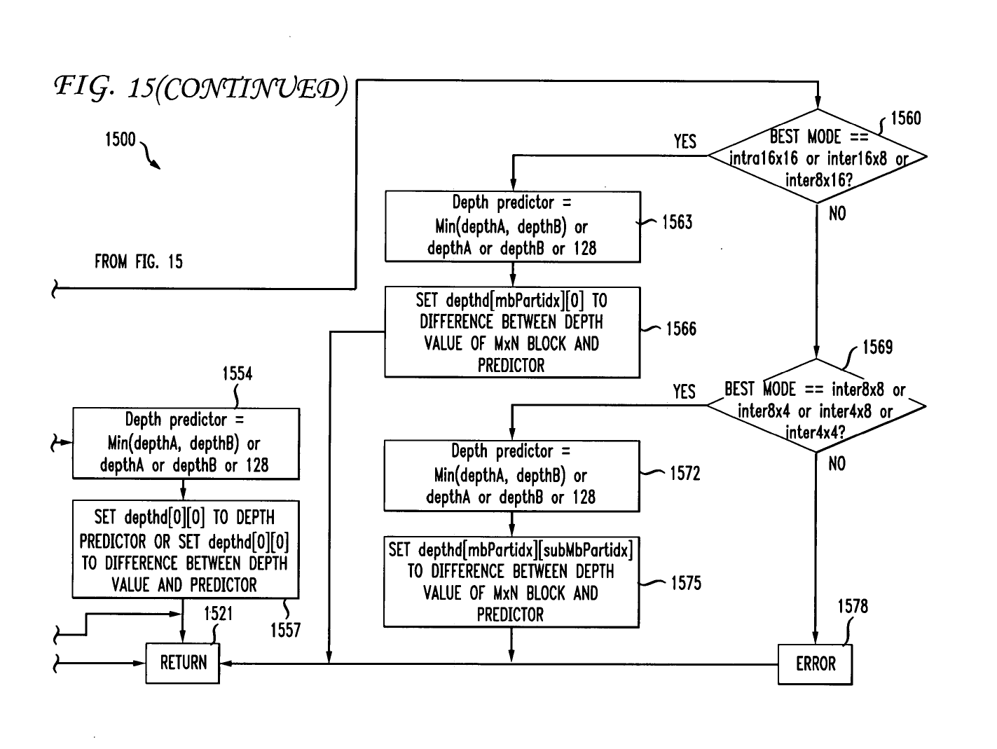

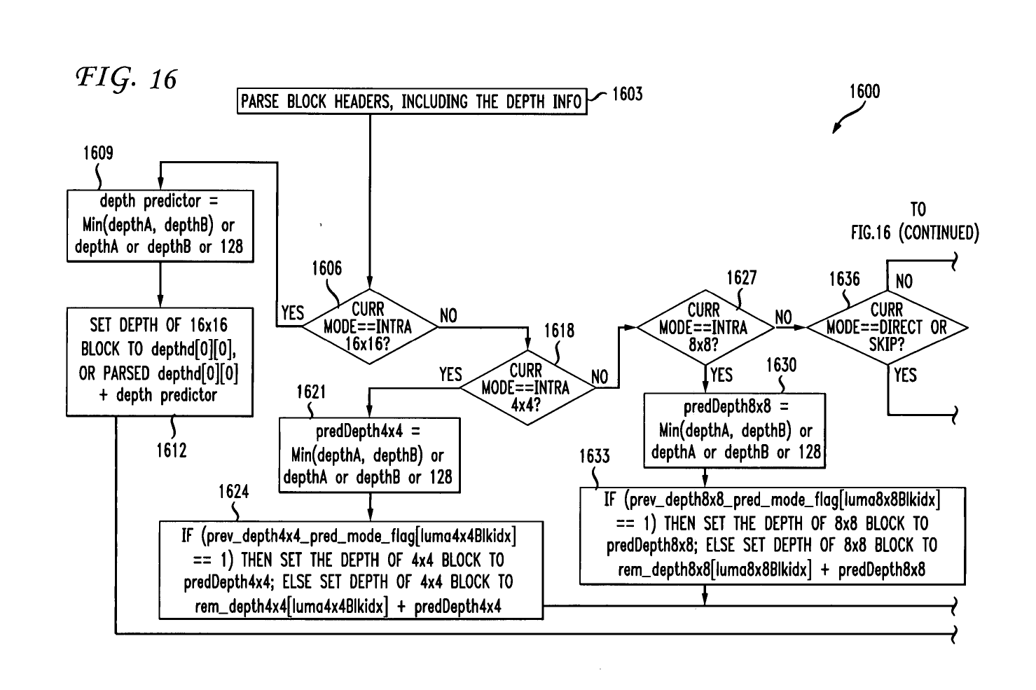

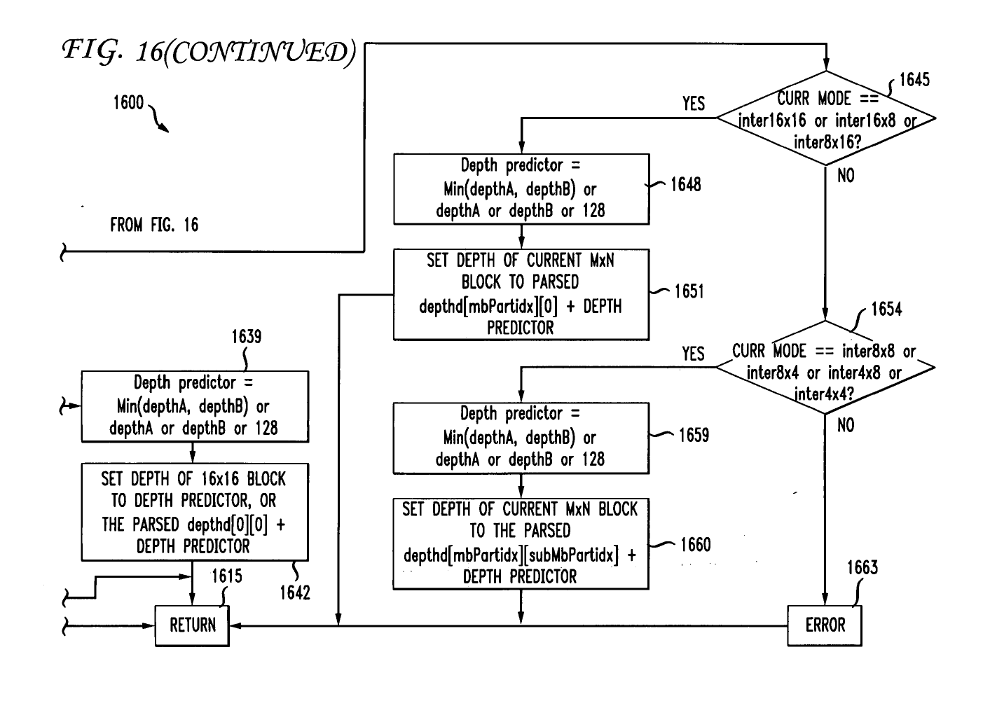

FIGS. 15 and 16 illustrate examples of methods for encoding and decoding, respectively, video data including a depth signal in accordance with Embodiment 1.

In particular, FIG. 15 is a flow diagram showing a method 1500 for encoding video data including a depth signal in accordance with a first embodiment (Embodiment 1). At step 1503, macroblock modes are checked. At step 1506, intra4×4, intra16×16, and intra8×8 modes are checked. At step 1509, it is determined whether or not the current slice is an I slice. If so, then control is passed to a step 1512. Otherwise, control is passed to a step 1524.

At step 1512, it is determined whether or not the best mode==intra 16×16. If so, then control is passed to a step 1515. Otherwise, control is passed to a step 1533.

At step 1515, the depth predictor is set equal to Min(depthA, depthB) or depthA or depthB or 128. At step 1518, depthd[0][0] is set to the absolute value of the depth at the location or to the difference between the depth value and the predictor. At step 1521, a return is made.

At step 1524, it is determined whether or not the current slice is a P slice. If so, then control is passed to a step 1527. Otherwise, control is passed to a step 1530.

At step 1527, all inter-modes related to a P slice are checked.

At step 1530, all inter-modes related to a B slice are checked.

At step 1533, it is determined whether or not the best mode==intra4×4. If so, then control is passed to a step 1548. Otherwise, control is passed to a step 1536.

At step 1548, predDepth4×4 is set equal to Min(depthA, depthB) or depthA or depthB or 128. At step 1551, if depth of 4×4 block==predDepth4×4, then set prev_depth4×4_pred_mode_flag[luma4×4BlkIdx]=1; otherwise, set prev_depth4×4_pred_mode_flag[luma4×4BlkIdx]=0, and send rem_depth4×4[luma4×4BlkIdx] as the difference between depth4×4 and predDepth4×4.

At step 1536, it is determined whether or not best mode==intra8×8. If so, then control is passed to a step 1542. Otherwise, control is passed to a step 1539.

At step 1542, predDepth8×8=Min(depthA, depthB) or depthA or depthB or 128. At step 1545, if depth of 8×8 block==predDepth8×8, then set prev_depth8×8_pred_mode_flag[luma8×8BlkIdx]=1; otherwise, set prev_depth8×8_pred_mode_flag[luma8×8BlkIdx]=0, and send rem_depth8×8[luma8×8BlkIdx] as the difference between depth8×8 and predDepth8×8.

At step 1539, it is determined whether or not best mode==Direct or SKIP. If so, then control is passed to a step 1554. Otherwise, control is passed to a step 1560.

At step 1554, the depth predictor is set equal to Min(depthA, depthB) or depthA or depthB or 128. At step 1557, depthd[0][0] is set equal to the depth predictor or to the difference between the depth value and the predictor.

At step 1560, it is determined whether or not best mode==inter16×16 or inter16×8 or inter8×16. If so, then control is passed to a step 1563. Otherwise, control is passed to a step 1569.

At step 1563, the depth predictor is set equal to Min(depthA, depthB) or depthA or depthB or 128. At step 1566, depthd[mbPartIdc][0] is set to the difference between the depth value of the M×N block and the predictor.

At step 1569, it is determined whether or not best mode==inter8×8 or inter8×4 or inter4×8 or inter4×4. If so, then control is passed to a step 1572. Otherwise, control is passed to a step 1578.

At step 1572, the depth predictor is set equal to Min(depthA, depthB) or depthA or depthB or 128. At step 1575, depthd[mbPartIdx][subMBPartIdx] is set to the difference between the depth value of the M×N block and the predictor.

At step 1578, an error is indicated.

FIG. 16 is a flow diagram showing a method 1600 for decoding video data including a depth signal in accordance with a first embodiment (Embodiment 1). At step 1603, block headers including depth information are parsed. At step 1606, it is determined whether or not current (curr) mode==intra16×16. If so, then control is passed to a step 1609. Otherwise, control is passed to a step 1618.

At step 1609, the depth predictor is set to Min(depthA, depthB) or depthA or depthB or 128. At step 1612, the depth of the 16×16 block is set to be depthd[0][0] or to the parsed depthd[0][0]+depth predictor. At step 1615, a return is made.

At step 1618, it is determined whether or not curr mode==intra4×4. If so, then control is passed to a step 1621. Otherwise, control is passed to a step 1627.

At step 1621, predDepth4×4 is set equal to Min(depthA, depthB) or depthA or depthB or 128. At step 1624, if prev_depth4×4_pred_mode_flag[luma4×4BlkIdx]==1 then the depth of the 4×4 block is set equal to predDepth4×4; otherwise, the depth of the 4×4 block is set equal to rem_depth4×4[luma4×4BlkIdx]+predDepth4×4.

At step 1627, it is determined whether or not curr mode==intra8×8. If so, then control is passed to a step 1630. Otherwise, control is passed to a step 1636.

At step 1630, predDepth8×8 is set equal to Min(depthA, depthB) or depthA or depthB or 128. At step 1633, if prev_depth8×8_pred_mode_flag[luma8×8BlkIdx]==1 then the depth of the 8×8 block is set equal to predDepth8×8; otherwise, the depth of the 8×8 block is set equal to rem_depth8×8[luma8×8BlkIdx]+predDepth8×8.

At step 1636, it is determined whether or not curr mode==Direct or SKIP. If so, then control is passed to a step 1639. Otherwise, control is passed to a step 1645.

At step 1639, the depth predictor is set equal to Min(depthA, depthB) or depthA or depthB or 128. At step 1642 the depth of the 16×16 block is set equal to the depth predictor, or parsed depth[0][0]+depth predictor.

At step 1645, it is determined whether or not curr mode==inter16×16 or inter16×8 or inter8×16. If so, then control is passed to a step 1648. Otherwise, control is passed to a step 1654.

At step 1648, the depth predictor is set to Min(depthA, depthB) or depthA or depthB or 128. At step 1651, the depth of the current M×N block is set equal to parsed depthd[mbPartIdx][0]+depth predictor.

At step 1654, it is determined whether or not curr mode==inter8×8 or inter8×4 or inter4×8 or inter4×4. If so, then control is passed to a step 1659. Otherwise, control is passed to a step 1663.

At step 1659, the depth predictor is set to Min(depthA, depthB) or depthA or depthB or 128. At step 1660, the depth of the current M×N block is set equal to parsed depthd[mbPartIdc][subMBPartIdx]+depth predictor.

At step 1663, an error is indicated.

### Embodiment 2

In this embodiment, we propose that the depth signal be predicted by motion information for inter blocks. The motion information is the same as that associated with the video signal. The depth for intra blocks are the same as Embodiment 1. We propose predDepthSkip be derived using the motion vector information. Accordingly, we add an additional reference buffer to store the full resolution depth signal. The syntax and the derivation for inter blocks are the same as Embodiment 1.

In one embodiment, we set predDepthSkip=DepthRef(x+mvx, y+mvy), x, y are the coordinates of the upper-left pixel of the target block, mvx and mvy are the x and y component of motion vector associated with the current macroblock from the video signal and DepthRef is the reconstructed reference depth signal that is stored in the decoded picture buffer (DPB).

In another embodiment, we set predDepthSkip to be the average of all reference depth pixels pointed to by motion vectors for the target block.

In another embodiment, we can assume mvx=mvy=0, so we use the collocated block depth value for prediction, i.e., predDepthSkip=DepthRef(x, y).

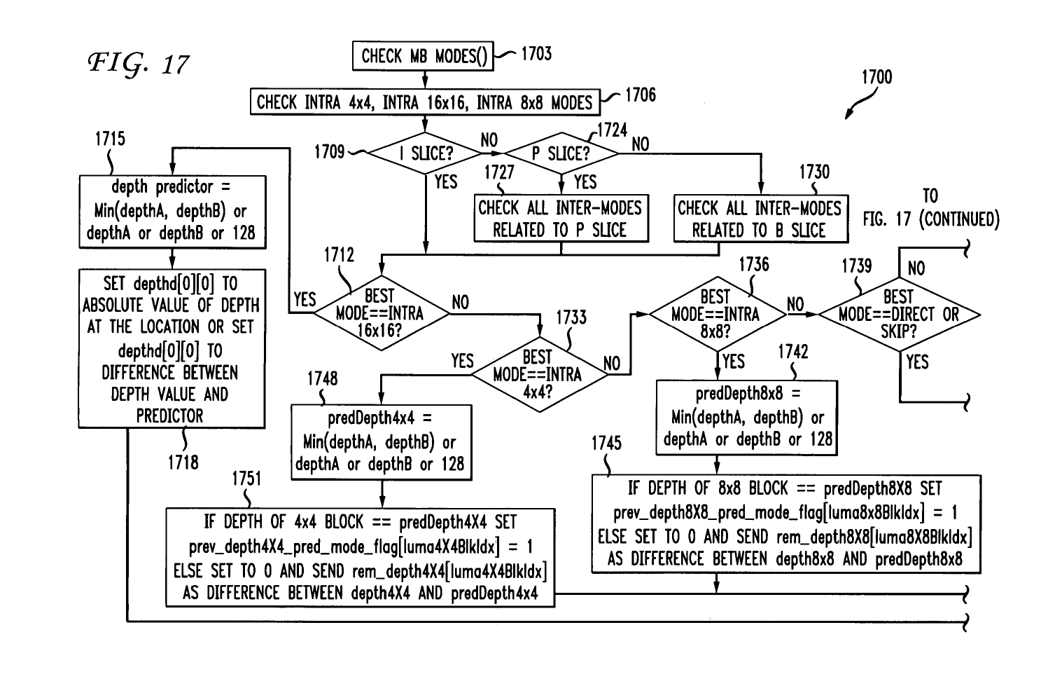

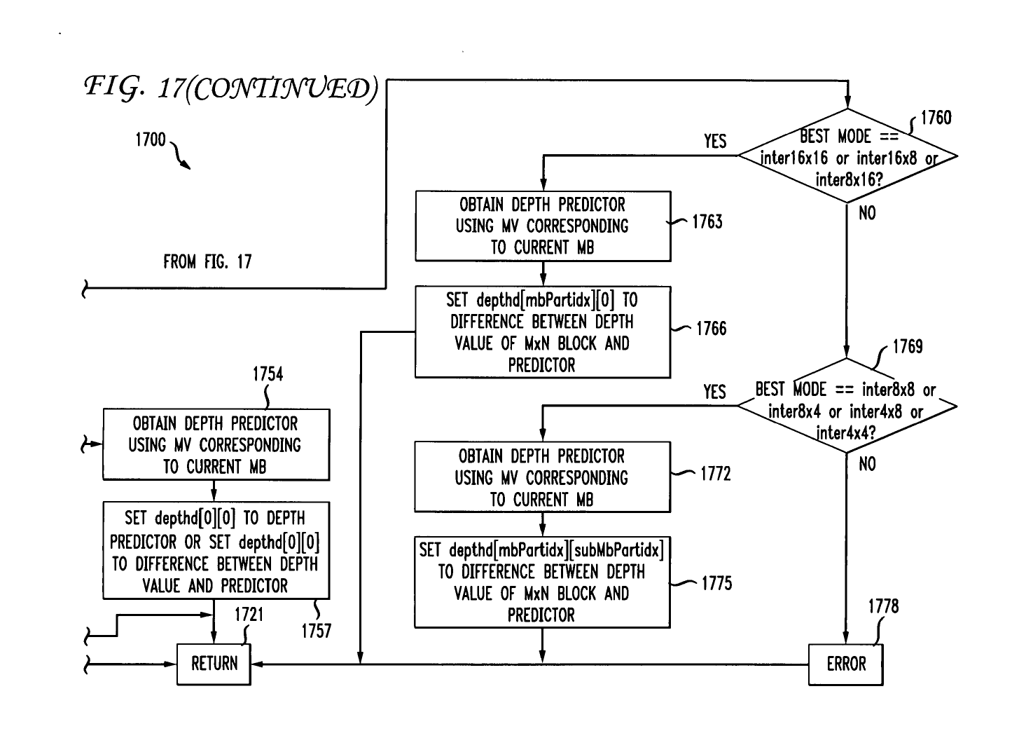

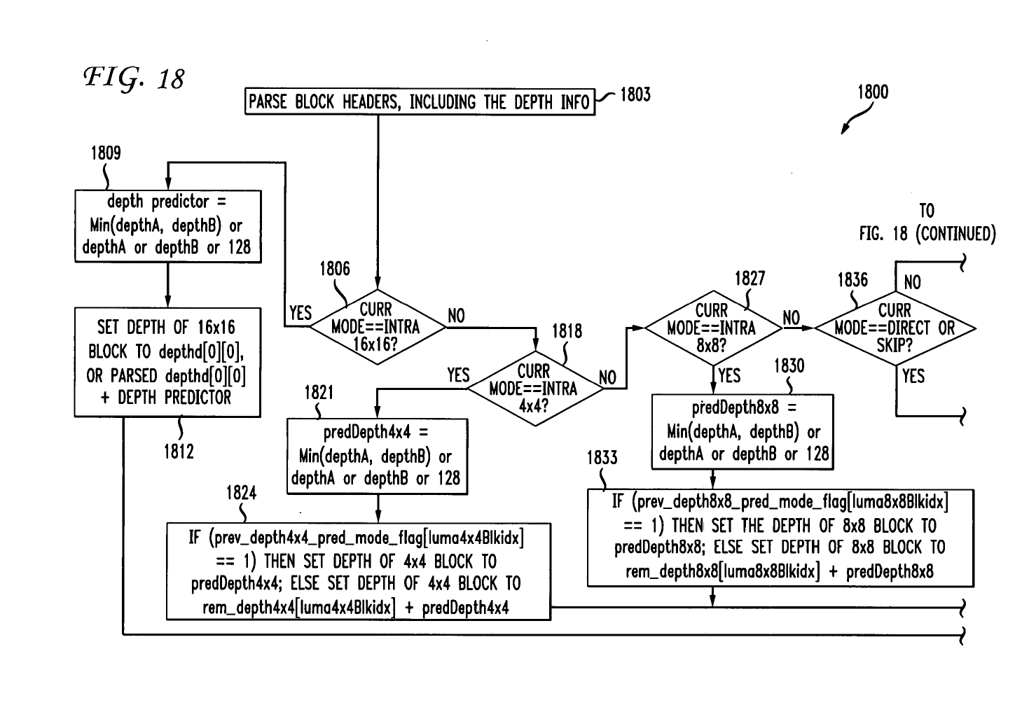

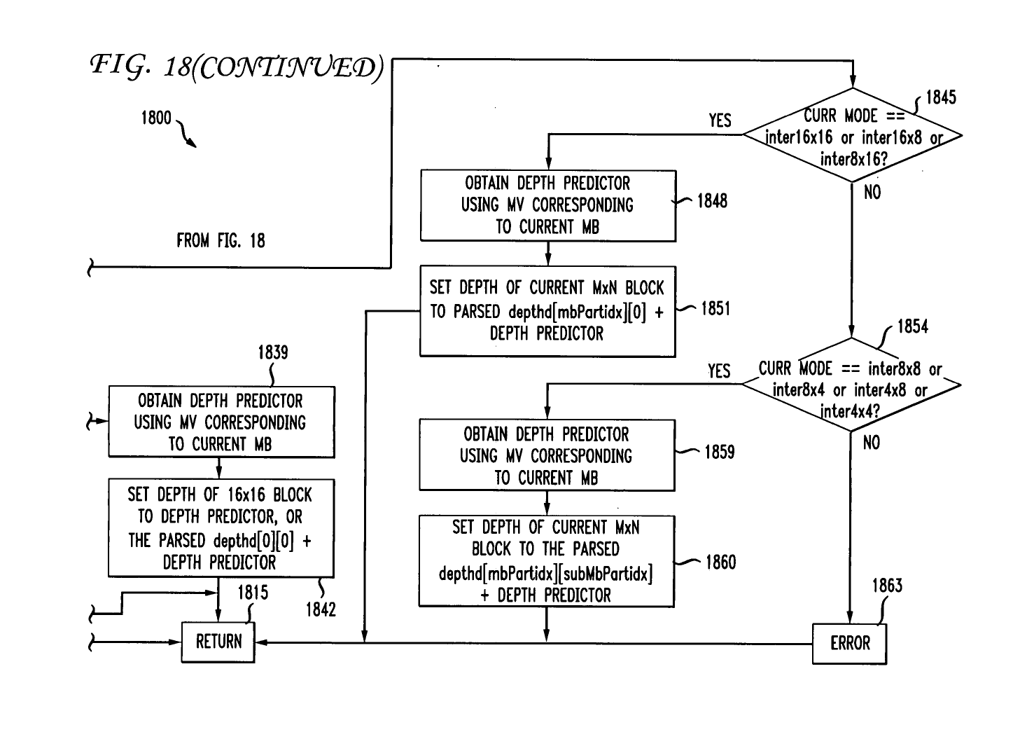

FIGS. 17 and 18 illustrate examples of methods for encoding and decoding, respectively, video data including a depth signal in accordance with Embodiment 2.

FIG. 17 is a flow diagram showing a method 1700 for encoding video data including a depth signal in accordance with a second embodiment (Embodiment 2). At step 1703, macroblock modes are checked. At step 1706, intra4×4, intra16×16, and intra8×8 modes are checked. At step 1709, it is determined whether or not the current slice is an I slice. If so, then control is passed to a step 1712. Otherwise, control is passed to a step 1724.

At step 1712, it is determined whether or not the best mode==intra 16×16. If so, then control is passed to a step 1715. Otherwise, control is passed to a step 1733.

At step 1715, the depth predictor is set equal to Min(depthA, depthB) or depthA or depthB or 128. At step 1718, depthd[0][0] is set to the absolute value of the depth at the location or to the difference between the depth value and the predictor. At step 1721, a return is made.

At step 1724, it is determined whether or not the current slice is a P slice. If so, then control is passed to a step 1727. Otherwise, control is passed to a step 1730.

At step 1727, all inter-modes related to a P slice are checked.

At step 1730, all inter-modes related to a B slice are checked.

At step 1733, it is determined whether or not the best mode==intra4×4. If so, then control is passed to a step 1748. Otherwise, control is passed to a step 1736. At step 1748, predDepth4×4 is set equal to Min(depthA, depthB) or depthA or depthB or 128. At step 1751, if depth of 4×4 block==predDepth4×4, then set prev_depth4×4_pred_mode_flag[luma4×4BlkIdx]=1; otherwise, set prev_depth4×4_pred_mode_flag[luma4×4BlkIdx]=0, and send rem_depth4×4[luma4×4BlkIdx] as the difference between depth4×4 and predDepth4×4.

At step 1736, it is determined whether or not best mode==intra8×8. If so, then control is passed to a step 1742. Otherwise, control is passed to a step 1739.

At step 1742, predDepth8×8=Min(depthA, depthB) or depthA or depthB or 128. At step 1745, if depth of 8×8 block==predDepth8×8, then set prev_depth8×8_pred_mode_flag[luma8×8BlkIdx]=1; otherwise, set prev_depth8×8_pred_mode_flag[luma8×8BlkIdx]=0, and send rem_depth8×8[luma8×8BlkIdx] as the difference between depth8×8 and predDepth8×8.

At step 1739, it is determined whether or not best mode==Direct or SKIP. If so, then control is passed to a step 1754. Otherwise, control is passed to a step 1760.

At step 1754, the depth predictor is obtained using the motion vector (MV) corresponding to the current macroblock (MB). At step 1757, depthd[0][0] is set equal to the depth predictor or to the difference between the depth value and the predictor.

At step 1760, it is determined whether or not best mode==inter16×16 or inter16×8 or inter8×16. If so, then control is passed to a step 1763. Otherwise, control is passed to a step 1769.

At step 1763, the depth predictor is obtained using the motion vector (MV) corresponding to the current macroblock (MB). At step 1766, depthd[mbPartIdc]0] is set to the difference between the depth value of the M×N block and the predictor.

At step 1769, it is determined whether or not best mode==inter8×8 or inter8×4 or inter4×8 or inter4×4. If so, then control is passed to a step 1772. Otherwise, control is passed to a step 1778.

At step 1772, the depth predictor is obtained using the motion vector (MV) corresponding to the current macroblock (MB). At step 1775, depthd[mbPartIdx][subMBPartIdx] is set to the difference between the depth value of the M×N block and the predictor.

At step 1778, an error is indicated.

FIG. 18 is a flow diagram showing a method 1800 for decoding video data including a depth signal in accordance with a second embodiment (Embodiment 2). At step 1803, block headers including depth information are parsed. At step 1806, it is determined whether or not current (curr) mode==intra16×16. If so, then control is passed to a step 1809. Otherwise, control is passed to a step 1818.

At step 1809, the depth predictor is set to Min(depthA, depthB) or depthA or depthB or 128. At step 1812, the depth of the 16×16 block is set equal to depthd[0][0], or parsed depthd[0][0]+depth predictor. At step 1815, a return is made.

At step 1818, it is determined whether or not curr mode==intra4×4. If so, then control is passed to a step 1821. Otherwise, control is passed to a step 1827.

At step 1821, predDepth4×4 is set equal to Min(depthA, depthB) or depthA or depthB or 128. At step 1824, if prev_depth4×4_pred_mode_flag[luma4×4BlkIdx]==1 then the depth of the 4×4 block is set equal to predDepth4×4; otherwise, the depth of the 4×4 block is set equal to rem_depth4×4[luma4×4BlkIdx]+predDepth4×4.

At step 1827, it is determined whether or not curr mode==intra8×8. If so, then control is passed to a step 1830. Otherwise, control is passed to a step 1836.

At step 1830, predDepth8×8 is set equal to Min(depthA, depthB) or depthA or depthB or 128. At step 1833, if prev_depth8×8_pred_mode_flag[luma8×8BlkIdx]==1 then the depth of the 8×8 block is set equal to predDepth8×8; otherwise, the depth of the 8×8 block is set equal to rem_depth8×8[luma8×8BlkIdx]+predDepth8×8.

At step 1836, it is determined whether or not curr mode==Direct or SKIP. If so, then control is passed to a step 1839. Otherwise, control is passed to a step 1645.

At step 1839, the depth predictor is obtained using the motion vector (MV) corresponding to the current macroblock (MB). At step 1842, the depth of the 16×16 block is set equal to the depth predictor, or to the parsed depth[0][0]+depth predictor.

At step 1845, it is determined whether or not curr mode==inter16×16 or inter16×8 or inter8×16. If so, then control is passed to a step 1848. Otherwise, control is passed to a step 1854.

At step 1848, the depth predictor is obtained using the motion vector (MV) corresponding to the current macroblock (MB). At step 1851, the depth of the current M×N block is set equal to parsed depthd[mbPartIdx][0]+depth predictor.

At step 1854, it is determined whether or not curr mode==inter8×8 or inter8×4 or inter4×8 or inter4×4. If so, then control is passed to a step 1659. Otherwise, control is passed to a step 1863.

At step 1859, the depth predictor is obtained using the motion vector (MV) corresponding to the current macroblock (MB). At step 1860, the depth of the current M×N block is set equal to parsed depthd[mbPartIdc][subMBPartIdx]+depth predictor.

At step 1863, an error is indicated.

The embodiments of FIGS. 13, 15, and 17 are capable of encoding video data including a depth signal. The depth signal need not be encoded, but may be encoded using, for example, differential encoding and/or entropy encoding. Analogously, the embodiments of FIGS. 14, 16, and 18 are capable of decoding video data including a depth signal. The data received and decoded by FIGS. 14, 16, and 18 may be data provided, for example, by one of the embodiments of FIG. 13, 15, or 17. The embodiments of FIGS. 14, 16, and 18 are capable of processing depth values in various ways. Such processing may include, for example, and depending on the implementation, parsing the received depth values, decoding the depth values (assuming that the depth values had been encoded), and generating all or part of a depth map based on the depth values. Note that a processing unit, for processing depth values, may include, for example, (1) a bitstream parser 202, (2) depth representative calculator 211 which may perform various operations such as adding in a predictor value for those implementations in which the depth value is a difference from a predicted value, (3) depth map reconstructer 212, and (4) entropy decoder 205 which may be used in certain implementations to decode depth values that are entropy coded.

### Depth Data Interpolation

In various implementations, we interpolate the depth data to its full resolution. That is, the decoder receives depth data (such as a single depthd coded value that is decoded to produce a single depth value) and generates a full per-pixel depth map for the associated region (such as a macroblock or sub-macroblock). We can do simple copying (zero-th order interpolation), i.e., fill the block with the same value of depthM×N (M, N=16, 8, 4). We can also apply other more sophisticated interpolation methods, such as bilinear, bicubic interpolation, and so forth. That is, the present principles are not limited to any particular interpolation method and, thus, any interpolation method may be used in accordance with the present principles, while maintaining the spirit of the present principles. A filter can be applied before or after the interpolation.

The following points may elaborate, at least in part, on concepts previously discussed and provide details of various implementations. Such implementations below may correspond to earlier implementations, or present variations and/or new implementations.

Various implementations can be referred to as providing a 3D motion vector (MV). A motion vector usually is 2D, having (x,y), and in various implementations we add a single value for depth (“D”), and the depth value may be considered to be a third dimension for the motion vector. Depth may be coded, alternatively, as a separate picture which could then be encoded using AVC coding techniques.

As indicated earlier, the partitions of a macroblock will often be of satisfactory size for depth as well. For example, flat areas will generally be amenable to large partitions because a single motion vector will suffice, and those flat areas are also amenable to large partitions for depth coding too because they are flat and so the use of a single depth value for the flat partition value will generally provide a good encoding. Further, the motion vector points us to partitions that might be good for use in determining or predicting the depth (D) value. Thus, depth could be predictively encoded.

Implementations may use a single value for depth for the entire partition (sub-macroblock). Other implementations may use multiple values, or even a separate value for each pixel. The value(s) used for depth may be determined, as shown above for several examples, in various ways such as, for example, a median, an average, or a result of another filtering operation on the depth values of the sub-macroblock. The depth value(s) may also be based on the values of depth in other partitions/blocks. Those other partitions/blocks may be in the same picture (spatially adjacent or not), in a picture from another view, or in a picture from the same view at another temporal instance. Basing the depth value(s) on depth from another partition/block may use a form of extrapolation, for example, and may be based on reconstructed depth values from those partition(s)/block(s), encoded depth values, or actual depth values prior to encoding.

Depth value predictors may be based on a variety of pieces of information. Such information includes, for example, the depth value determined for a nearby (either adjacent or not) macroblock or sub-macroblock, and/or the depth value determined for corresponding macroblock or sub-macroblock pointed to by a motion vector. Note that in some modes of certain embodiments, a single depth value is produced for an entire macroblock, while in other modes a single depth value is produced for each partition in a macroblock.

It is to be appreciated that the inventive concept could be applied to only a single macroblock if desired, or any subset or portions of a picture. Moreover, as used herein, the term “picture” can be, e.g., a frame or a field.

AVC refers more specifically to the existing International Organization for Standardization/International Electrotechnical Commission (ISO/IEC) Moving Picture Experts Group-4 (MPEG-4) Part 10 Advanced Video Coding (AVC) standard/International Telecommunication Union, Telecommunication Sector (ITU-T) H.264 Recommendation (hereinafter the “H.264/MPEG-4 AVC Standard” or variations thereof, such as the “AVC standard” or simply “AVC”). MVC typically refers more specifically to a multi-view video coding (“MVC”) extension (Annex H) of the AVC standard, referred to as H.264/MPEG-4 AVC, MVC extension (the “MVC extension” or simply “MVC”). SVC typically refers more specifically to a scalable video coding (“SVC”) extension (Annex G) of the AVC standard, referred to as H.264/MPEG-4 AVC, SVC extension (the “SVC extension” or simply “SVC”).

Several of the implementations and features described in this application may be used in the context of the H.264/MPEG-4 AVC (AVC) standard, or the AVC standard with the MVC extension, or the AVC standard with the SVC extension. However, these implementations and features may be used in the context of another standard (existing or future), or in a context that does not involve a standard.

Additionally, implementations may signal information using a variety of techniques including, but not limited to, SEI messages, slice headers, other high level syntax, non-high-level syntax, out-of-band information, datastream data, and implicit signaling. Signaling techniques may vary depending on whether a standard is used and, if a standard is used, on which standard is used.

Reference in the specification to “one embodiment” or “an embodiment” or “one implementation” or “an implementation” of the present principles, as well as other variations thereof, mean that a particular feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding and decoding. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette, a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

We thus provide one or more implementations having particular features and aspects. However, features and aspects of described implementations may also be adapted for other implementations. Accordingly, although implementations described herein may be described in a particular context, such descriptions should in no way be taken as limiting the features and concepts to such implementations or contexts.

It will also be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application and are within the scope of the following claims.

1. A method comprising:
decoding an encoded first portion of an image using a first-portion motion vector associated with the first portion and not associated with other portions of the image, the first-portion motion vector indicating a corresponding portion in a reference image to be used in decoding the first portion, and the first portion having a first size;
processing a first-portion depth value, the first-portion depth value providing depth information for the entire first portion and not for other portions;
decoding an encoded second portion of the image using a second-portion motion vector associated with the second portion and not associated with other portions of the image, the second-portion motion vector indicating a corresponding portion in the reference image to be used in decoding the second portion, and the second portion having a second size that is different from the first size; and
processing a second-portion depth value, the second-portion depth value providing depth information the entire second portion and not for other portions.

2. The method of claim 1 wherein the first-portion depth value is an encoded and processing the first-portion depth value comprises decoding the first-portion depth value.

3. The method of claim 1 wherein processing the first-portion depth value comprises one or more of parsing the first-portion depth value, decoding the first-portion depth value, or generating at least part of a depth map based on the first-portion depth value.

4. The method of claim 1 wherein processing the first-portion depth value comprises generating a first portion of a depth map based on the first-portion depth value, the first portion of the depth map having a separate depth value for each pixel in the first portion of the image.

5. The method of claim 4, wherein:
the first-portion depth value is a residue determined from a depth predictor at an encoder, and
generating the first portion of the depth map comprises:
generating a prediction for a representative depth value that represents actual depth for the entire first portion;
combining the prediction with the first-portion depth value to determine a reconstructed representative depth value for the first portion of the image; and
populating the first portion of the depth map based on the reconstructed representative depth value.

6. The method of claim 5, wherein populating comprises copying the reconstructed representative depth value to the entire first portion of the depth map.

7. The method of claim 1 wherein the first portion is a macroblock or sub-macroblock, and the second portion is a macroblock or sub-macroblock.

8. The method of claim 1 further comprising providing the decoded first portion and decoded second portion for display.

9. The method of claim 1, further comprising accessing a structure that includes the first-portion depth value and the first-portion motion vector.

10. The method of claim 1, wherein the first-portion depth value is based on one or more of an average of depth for the first portion, a median of depth for the first portion, depth information for a neighboring portion in the image, or depth information for a portion in a corresponding temporal or inter-view portion.

11. The method of claim 1, wherein:
the first-portion depth value is a residue determined from a depth predictor at an encoder, and
the method further comprises generating a prediction for a representative depth value that represents actual depth for the entire first portion, and the prediction is based on one or more of an average of depth for the first portion, a median of depth for the first portion, depth information for a neighboring portion in the image, or depth information for a portion in a corresponding temporal or inter-view portion.

12. The method of claim 1, wherein the first-portion depth value is a representative depth value that represents actual depth for the entire first portion.

13. The method of claim 1, wherein the method is performed at a decoder.

14. The method of claim 1, wherein the method is performed at an encoder.

15. An apparatus comprising:
means for decoding an encoded first portion of an image using a first-portion motion vector associated with the first portion and not associated with other portions of the image, the first-portion motion vector indicating a corresponding portion in a reference image to be used in decoding the first portion, and the first portion having a first size;
means for processing a first-portion depth value, the first-portion depth value providing depth information for the entire first portion and not for other portions;
means for decoding an encoded second portion of the image using a second-portion motion vector associated with the second portion and not associated with other portions of the image, the second-portion motion vector indicating a corresponding portion in the reference image to be used in decoding the second portion, and the second portion having a second size that is different from the first size; and
means for processing a second-portion depth value, the second-portion depth value providing depth information the entire second portion and not for other portions.

16. A processor readable medium having stored thereon instructions for causing a processor to perform at least the following:
decoding an encoded first portion of an image using a first-portion motion vector associated with the first portion and not associated with other portions of the image, the first-portion motion vector indicating a corresponding portion in a reference image to be used in decoding the first portion, and the first portion having a first size;
processing a first-portion depth value, the first-portion depth value providing depth information for the entire first portion and not for other portions;
decoding an encoded second portion of the image using a second-portion motion vector associated with the second portion and not associated with other portions of the image, the second-portion motion vector indicating a corresponding portion in the reference image to be used in decoding the second portion, and the second portion having a second size that is different from the first size; and
processing a second-portion depth value, the second-portion depth value providing depth information the entire second portion and not for other portions.

17. An apparatus, comprising a processor configured to perform at least the following:
decoding an encoded first portion of an image using a first-portion motion vector associated with the first portion and not associated with other portions of the image, the first-portion motion vector indicating a corresponding portion in a reference image to be used in decoding the first portion, and the first portion having a first size;
processing a first-portion depth value, the first-portion depth value providing depth information for the entire first portion and not for other portions;
decoding an encoded second portion of the image using a second-portion motion vector associated with the second portion and not associated with other portions of the image, the second-portion motion vector indicating a corresponding portion in the reference image to be used in decoding the second portion, and the second portion having a second size that is different from the first size; and
processing a second-portion depth value, the second-portion depth value providing depth information the entire second portion and not for other portions.

18. An apparatus comprising a decoding unit for performing the following operations:
decoding an encoded first portion of an image using a first-portion motion vector associated with the first portion and not associated with other portions of the image, the first-portion motion vector indicating a corresponding portion in a reference image to be used in decoding the first portion, and the first portion having a first size;
processing a first-portion depth value, the first-portion depth value providing depth information for the entire first portion and not for other portions;
decoding an encoded second portion of the image using a second-portion motion vector associated with the second portion and not associated with other portions of the image, the second-portion motion vector indicating a corresponding portion in the reference image to be used in decoding the second portion, and the second portion having a second size that is different from the first size; and
processing a second-portion depth value, the second-portion depth value providing depth information the entire second portion and not for other portions.

19. The apparatus of claim 18, wherein the apparatus comprises an encoder.

20. A decoder comprising:
a demodulator for receiving and demodulating a signal, the signal including an encoded first portion of an image and a depth value representative of a first portion of depth information, the first portion of depth information corresponding to the first portion of the image;
a decoding unit for performing the following operations:
decoding an encoded first portion of an image using a first-portion motion vector associated with the first portion and not associated with other portions of the image, the first-portion motion vector indicating a corresponding portion in a reference image to be used in decoding the first portion, and the first portion having a first size, and
decoding an encoded second portion of the image using a second-portion motion vector associated with the second portion and not associated with other portions of the image, the second-portion motion vector indicating a corresponding portion in the reference image to be used in decoding the second portion, and the second portion having a second size that is different from the first size; and
a processing unit for performing the following operations:
processing a first-portion depth value, the first-portion depth value providing depth information for the entire first portion and not for other portions, and
processing a second-portion depth value, the second-portion depth value providing depth information the entire second portion and not for other portions.

21-22. (canceled)

23. A non-transitory processor readable medium having stored thereon a video signal structure, comprising:
a first image section for an encoded first portion of an image, the first portion having a first size;
a first depth section for a first-portion depth value, the first-portion depth value providing depth information for the entire first portion and not for other portions;
a first motion-vector section for a first-portion motion vector used in encoding the first portion of the image, the first-portion motion vector associated with the first portion and not associated with other portions of the image, the first-portion motion vector indicating a corresponding portion in a reference image to be used in decoding the first portion;
a second image section for an encoded second portion of an image, the second portion having a second size that is different from the first size;
a second depth section for a second-portion depth value, the second-portion depth value providing depth information for the entire second portion and not for other portions; and
a second motion-vector section for a second-portion motion vector used in encoding the second portion of the image, the second-portion motion vector associated with the second portion and not associated with other portions of the image, the second-portion motion vector indicating a corresponding portion in a reference image to be used in decoding the second portion.

24. A method comprising:
encoding a first portion of an image using a first-portion motion vector that is associated with the first portion and not associated with other portions of the image, the first-portion motion vector indicating a corresponding portion in a reference image to be used in encoding the first portion, and the first portion having a first size;
determining a first-portion depth value that provides depth information for the entire first portion and not for other portions;
encoding a second portion of an image using a second-portion motion vector that is associated with the second portion and not associated with other portions of the image, the second-portion motion vector indicating a corresponding portion in a reference image to be used in encoding the second portion, and the second portion having a second size that is different from the first size;
determining a second-portion depth value that provides depth information for the entire second portion and not for other portions; and
assembling the encoded first portion, the first-portion depth value, the encoded second portion, and the second-portion depth value into a structured format.

25. The method of claim 24 further comprising providing the structured format for transmission or storage.

26. The method of claim 24 wherein determining the first-portion depth value is based on a first portion of a depth map, the first portion of the depth map having a separate depth value for each pixel in the first portion of the image.

27. The method of claim 24 further comprising encoding the first-portion depth value and the second-portion depth value prior to assembling, such that assembling the first-portion depth value and the second-portion depth value into the structured format comprises assembling the encoded versions of the first-portion depth value and second-portion depth value.

28. The method of claim 24, further comprising:
determining a representative depth value that represents actual depth for the entire first portion;
generating a prediction for the representative depth value; and
combining the prediction with the representative depth value to determine the first-portion depth value.

29. The method of claim 28, wherein generating the prediction comprises generating a prediction that is based on one or more of an average of depth for the first portion, a median of depth for the first portion, depth information for a neighboring portion in the image, or depth information for a portion in a corresponding temporal or inter-view portion.

30. The method of claim 24, wherein the first-portion depth value is based on one or more of an average of depth for the first portion, a median of depth for the first portion, depth information for a neighboring portion in the image, or depth information for a portion in a corresponding temporal or inter-view portion.

31. The method of claim 24 wherein the first portion is a macroblock or sub-macroblock, and the second portion is a macroblock or sub-macroblock.

32. The method of claim 24, wherein assembling further comprises assembling the first-portion motion vector into the structured format.

33. The method of claim 24, wherein the method is performed at an encoder.

34. An apparatus comprising:
means for encoding a first portion of an image using a first-portion motion vector that is associated with the first portion and not associated with other portions of the image, the first-portion motion vector indicating a corresponding portion in a reference image to be used in encoding the first portion, and the first portion having a first size;
means for determining a first-portion depth value that provides depth information for the entire first portion and not for other portions;
means for encoding a second portion of an image using a second-portion motion vector that is associated with the second portion and not associated with other portions of the image, the second-portion motion vector indicating a corresponding portion in a reference image to be used in encoding the second portion, and the second portion having a second size that is different from the first size;
means for determining a second-portion depth value that provides depth information for the entire second portion and not for other portions; and
means for assembling the encoded first portion, the first-portion depth value, the encoded second portion, and the second-portion depth value into a structured format.

35. A processor readable medium having stored thereon instructions for causing a processor to perform at least the following:
encoding a first portion of an image using a first-portion motion vector that is associated with the first portion and not associated with other portions of the image, the first-portion motion vector indicating a corresponding portion in a reference image to be used in encoding the first portion, and the first portion having a first size;
determining a first-portion depth value that provides depth information for the entire first portion and not for other portions;
encoding a second portion of an image using a second-portion motion vector that is associated with the second portion and not associated with other portions of the image, the second-portion motion vector indicating a corresponding portion in a reference image to be used in encoding the second portion, and the second portion having a second size that is different from the first size;
determining a second-portion depth value that provides depth information for the entire second portion and not for other portions; and
assembling the encoded first portion, the first-portion depth value, the encoded second portion, and the second-portion depth value into a structured format.

36. An apparatus, comprising a processor configured to perform at least the following:
encoding a first portion of an image using a first-portion motion vector that is associated with the first portion and not associated with other portions of the image, the first-portion motion vector indicating a corresponding portion in a reference image to be used in encoding the first portion, and the first portion having a first size;
determining a first-portion depth value that provides depth information for the entire first portion and not for other portions;
encoding a second portion of an image using a second-portion motion vector that is associated with the second portion and not associated with other portions of the image, the second-portion motion vector indicating a corresponding portion in a reference image to be used in encoding the second portion, and the second portion having a second size that is different from the first size;
determining a second-portion depth value that provides depth information for the entire second portion and not for other portions; and
assembling the encoded first portion, the first-portion depth value, the encoded second portion, and the second-portion depth value into a structured format.

37. An apparatus comprising:
an encoding unit for encoding a first portion of an image using a first-portion motion vector that is associated with the first portion and not associated with other portions of the image, the first-portion motion vector indicating a corresponding portion in a reference image to be used in encoding the first portion, and the first portion having a first size, and for encoding a second portion of an image using a second-portion motion vector that is associated with the second portion and not associated with other portions of the image, the second-portion motion vector indicating a corresponding portion in a reference image to be used in encoding the second portion, and the second portion having a second size that is different from the first size;
a depth representative calculator for determining a first-portion depth value that provides depth information for the entire first portion and not for other portions, and for determining a second-portion depth value that provides depth information for the entire second portion and not for other portions; and
an assembly unit for assembling the encoded first portion, the first-portion depth value, the encoded second portion, and the second-portion depth value into a structured format.

38. An encoder comprising:
an encoding unit for encoding a first portion of an image using a first-portion motion vector that is associated with the first portion and not associated with other portions of the image, the first-portion motion vector indicating a corresponding portion in a reference image to be used in encoding the first portion, and the first portion having a first size, and for encoding a second portion of an image using a second-portion motion vector that is associated with the second portion and not associated with other portions of the image, the second-portion motion vector indicating a corresponding portion in a reference image to be used in encoding the second portion, and the second portion having a second size that is different from the first size;
a depth representative calculator for determining a first-portion depth value that provides depth information for the entire first portion and not for other portions, and for determining a second-portion depth value that provides depth information for the entire second portion and not for other portions;
an assembly unit for assembling the encoded first portion, the first-portion depth value, the encoded second portion, and the second-portion depth value into a structured format; and
a modulator for modulating the structured format.
